(19) United States
(12) Patent Application Publication
(10) Pub. No.: US 2009/0007019 A1
(43) Pub. Date: Jan. 1, 2009

(54) Image processing device, image processing method, and computer program product

(75) Inventors: Koji Kobayashi, Kanagawa (JP); Hirohisa Inamoto, Kanagawa (JP); Yuka Kihara, Tokyo (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/153,685

(22) Filed: May 22, 2008

(30) Foreign Application Priority Data
Jun. 27, 2007 (JP) 2007-169634

(51) Int. Cl. G06F 3/048

(52) U.S. Cl. 715/838

(57) ABSTRACT

A thumbnail generating section of a server generates a plurality of thumbnail images from a registration image received through an external I/F section and stores the generated thumbnail images in an image DB. The image DB stores therein registration images received through the external I/F section and the thumbnail images generated by the thumbnail generating section. A display screen controlling section generates a display screen to be displayed by a client. The display screen controlling section controls the display screen by generating the display screen in adherence to screen control data transmitted from the client.

### CROSS-REFERENCE TO RELATED APPLICATIONS

The present application claims priority to and incorporates by reference the entire contents of Japanese priority document 2007-169634 filed in Japan on Jun. 27, 2007.

### BACKGROUND OF THE INVENTION

1. Field of the Invention

The present invention relates to technology for displaying thumbnail images on a display screen.

2. Description of the Related Art

Electronic filing devices are known in the art that digitalize paper documents using a scanner. Such devices have been used for commercial purposes in which a large number of paper documents are handled. In recent years, ease-of-handling and convenience of such devices are also receiving recognition in common offices because of availability of low-cost scanners, popularity of multifunction printers (MFP), and legislation regarding electronic documents (e-documents) and the like. As a result, instances in which paper documents are scanned and digitalized are increasing. Uses for image databases (DB) are also increasing. An image DB organizes digitalized document image data and photographic image data, as well as document data created using a personal computer (PC) application and the like, in a DB and collectively manages the pieces of data. Even when, for example, an original copy of a paper document is required to be stored, an image DB may be constructed because the image DB facilitates data management and retrieval. Various image databases are constructed, ranging from a large-scale DB provided in a server device and accessed by a large number of people to a personal-use DB constructed within an individual PC. MFPs of recent years include a function for storing documents in an internal hard disk drive (HDD). In some instances, the image DB is constructed based on the MFP.

Many times the user wants to see a certain image from the vast number of images stored in an image DB. If, for example, the user knows an image name (file name) of the image, the image name can be used to pinpoint and retrieve the image from the image DB. However, the often-used method is to select a certain image from a displayed thumbnail list. For example, when a document image is retrieved, a keyword search is performed and a thumbnail list of candidate images matching the keyword is displayed. The user then selects a desired image from the thumbnails displayed in the thumbnail list. Alternatively, a thumbnail list of all document images within a folder is displayed and the user selects a desired image from the thumbnails displayed in the thumbnail list.

A thumbnail list is a cluster of a plurality of minified images (thumbnail images) that are displayed in a certain manner on a screen. The user can easily understand contents of the original images from the minified images. In general, the resolution of the thumbnail images in the thumbnail list is significantly reduced to allow simultaneous display of many thumbnail images in a limited area.

In the thumbnail list such as this, when an image to be displayed is a photographic image, the user can understand a content of the photographic image with relative ease, even when the resolution of the thumbnail image is reduced. However, when the image to be displayed is a document image that is mainly text, the user has difficulty reading the text and understanding a content of the document image because the resolution of the thumbnail image is reduced. Therefore, when the user retrieves a document image such as this, the user is often required to display an enlarged view of each document image using a function, such as a viewer, to check the content, after the thumbnail list is displayed. Operability during retrieval is extremely poor. Moreover, particularly in a server-client system in which an image is transferred over a network from a server to a client, a high resolution image is required to be newly transferred when an image is displayed using the viewer. Therefore, when the user checks a large number of images, frequency of image transfer increases by the number of images being checked. A large amount of processing time is required, causing problems regarding productivity.

More processing time is required if a large number of thumbnail images are to be displayed in the thumbnail list. Therefore, particularly in the server-client system using the network, the number of thumbnail images that can be listed on a single screen (one page) often less. Therefore, a large number of thumbnails are to be displayed, they are divided over a plurality of pages. In such instances, stress experienced by the user over the time required to display the images can be decreased by the screen being changed in a manner similar to a page being turned. However, because only a small number of thumbnail images can be displayed on one screen, the user is required to turn the page (change the screen) many times to view all of thumbnail images to be listed. Moreover, the user cannot easily understand the whole aspect of the listed thumbnail images. Therefore, it is not rare for the user to be unable to find the desired image even after viewing all of the pages. As a result, operability is severely degraded. However, when the number of thumbnails displayed on a single screen is increased as a countermeasure, time is required to display the images, causing a decrease in productivity. The user also experiences stress caused by an increase in waiting time required until the images are displayed.

Time required to display the images is attributed to the following. When the images stored in the image DB are displayed in the thumbnail list, the thumbnail images are not dynamically created from original images stored in the image DB nor are the original images used as is every time the thumbnail list is displayed, namely every time a thumbnail list display screen is created. In general, the minified images (thumbnail images) that are reduced versions of the original images are stored in the image DB in advance, and the stored thumbnail images are used. The thumbnail images are used because use of the thumbnail images is more advantageous in terms of processing speed. For example, when the thumbnail list display screen is created using HyperText Markup Language (HTML) and the like in the server-client system, the server does not ordinarily create a screen in bitmap format. The server only creates an HTML document including links to image (file) names to be displayed. The client that receives the HTML document renders the links using browser software and generates a bitmap-format display screen. In this case, the server is required to transfer all thumbnail images to be listed to the client regardless of the image size of the thumbnail images on the screen (ordinarily specified by the server). Ordinarily, all images are transferred even when some of the images run over an edge of the display screen. Therefore, when the number of thumbnail images displayed on a single screen increases, volume of data required to be transferred also increases. Moreover, because a small volume of data is transferred many times, data transfer efficiency decreases, requiring time for the screen to be displayed on the client end. Specifically, the transfer efficiency decreases for a following reason. A packet length during data transfer is ordinarily fixed. Different files are not included in a single packet. Therefore, when a small volume of data (file) is transferred, a large amount of padding is required so that the packet length is the fixed length, thereby resulting in redundant transfer data. When a number of pieces of redundant transfer data increases, effects of the pieces of redundant transfer data become difficult to ignore. Generally, when the number of thumbnail images to be listed increases, load placed on the server also increases because access to a disk and the like increases.

To counter issues such as those described above, a technology has been developed in which a desired piece of information can be retrieved through a simple operation. In the technology disclosed for example in Japanese Patent Application Laid-open No. 2004-258838, thumbnail images are disposed on a two-dimensional map and the thumbnail images are displayed. When a user specifies a point within a certain small area, among a plurality of small areas into which the map is divided, a group of small areas centering around the specified small area is designated as an area to be enlarged. The thumbnail images disposed within the area to be enlarged are enlarged, i.e., contents of the thumbnail images are displayed in detail. As a result, the desired piece of information can be retrieved through a simple operation.

However, in the technology in Japanese Patent Application Laid-open No. 2004-258838, a binary display switching is performed. The binary display switching switches between a thumbnail display displaying the thumbnail images on the map and an enlarged display displaying the enlarged thumbnail images. Therefore, when the user does not know a position of the image to be retrieved on the map in the thumbnail display, the user may possibly be required to switch to the enlarged display and search thoroughly for the image to be retrieved. Magnification may also be insufficient in the enlarged display. When the number of thumbnail images displayed on the map during the thumbnail display increases, the image size of the thumbnail images decreases because the thumbnail images cannot be displayed so as to overlap. The thumbnail list may become incomprehensible. Moreover, when the number of thumbnail images displayed on the map increases, time may be required to display the images. Therefore, problems related to both operability and productivity may arise. To resolve such issues, a technology is desired that can, for example, display the thumbnail images in a list such as to allow the user to zoom freely, thereby enabling variable magnification, allow the user to more efficiently retrieve the desired image, and enhance productivity during retrieval.

### SUMMARY OF THE INVENTION

It is an object of the present invention to at least partially solve the problems in the conventional technology.

According to an aspect of the present invention, there is provided an image processing device including a generating section that uses an original image stored in an image storing section to generate a plurality of thumbnail images in image sizes differing from an image size of the original image; a receiving section that displays an image, which can be at least one of the original image and a thumbnail image, in a display section and receives screen control information indicating a display magnification from an information processing device that receives an input of an instruction to change the display magnification of displayed image; a screen controlling section that selects a thumbnail image, from among the plurality of thumbnail images generated by the generating section, of an image size matching with the display magnification, contained in the screen control information received by the receiving section, and generates display screen information including selected thumbnail image; and a transmitting section that transmits the display screen information to the image processing device, wherein the generating section generates at least a standard thumbnail image of a first standard display size set in advance to be smaller than a size of a display area of the display section.

According to another aspect of the present invention, there is provided an image processing method including generating, by employing an original image stored in an image storing section, a plurality of thumbnail images in image sizes differing from an image size of the original image; displaying in a display section an image, which can be at least one of the original image and a thumbnail image; receiving screen control information indicating a display magnification from an information processing device that receives an input of an instruction to change the display magnification of displayed image; selecting a thumbnail image, from among the plurality of thumbnail images generated at the generating, of an image size matching with the display magnification, contained in the screen control information received at the receiving, and generating display screen information including selected thumbnail image; and transmitting the display screen information to the image processing device, wherein the generating includes generating at least a standard thumbnail image of a first standard display size set in advance to be smaller than a size of a display area of the display section.

According to still another aspect of the present invention, there is provided a computer program product that includes computer program codes stored on a computer readable recording medium that when executed on a computer enables the computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of an image processing system according to a first embodiment of the present invention;

FIG. 2 is a block diagram of a detailed functional configuration of a thumbnail generating section shown in FIG. 1;

FIG. 3 is a block diagram of a hardware configuration of a server shown in FIG. 1;

FIG. 4 is a flowchart of an image registration operation according to the first embodiment;

FIG. 5 is a flowchart of a process for generating a thumbnail image performed by the server shown in FIG. 1;

FIG. 6 is a diagram of an example of a preview size and thumbnail sizes according to the first embodiment;

FIG. 7 is a flowchart of an image retrieval operation according to the first embodiment;

FIG. 8 is an example of a thumbnail list display screen according to the first embodiment;

FIG. 9 is a diagram of a thumbnail list view according to the first embodiment;

FIG. 10 is a flowchart of a process for generating a thumbnail list view performed by the server 110 shown in FIG. 1;

FIG. 11 is a diagram of an example of a thumbnail list display screen displayed during a process for enlarging and displaying thumbnail images according to the first embodiment;

FIG. 12 is a diagram of an example of the thumbnail list display screen displayed during the process for enlarging and displaying the thumbnail images according to the first embodiment;

FIG. 13 is a diagram of an example of the thumbnail list display screen displayed during the process for enlarging and displaying the thumbnail images according to the first embodiment;

FIG. 14 is a diagram of an example of the thumbnail list display screen displayed during the process for enlarging and displaying the thumbnail images according to the first embodiment;

FIG. 15 is a diagram of an example of the thumbnail list display screen displayed during the process for enlarging and displaying the thumbnail images according to the first embodiment;

FIG. 16 is a diagram of an example of a thumbnail image when the thumbnail image is enlarged (image size<display size), when the thumbnail image is displayed on a monitor of a client shown in FIG. 1;

FIG. 17 is a diagram of an example of a thumbnail image when the thumbnail image is reduced (image size>display size), when the thumbnail image is displayed on the monitor of the client shown in FIG. 1;

FIG. 18 is a diagram of an example of a thumbnail image when the thumbnail image is neither enlarged nor reduced (image size=display size) when the thumbnail image is displayed on the monitor of the client shown in FIG. 1;

FIG. 19 is a block diagram of a configuration of an image processing system according to a second embodiment of the present invention;

FIG. 20 is a flowchart of an image registration operation according to the second embodiment;

FIG. 21 is a diagram of an example of an initial screen of a thumbnail list display screen according to the second embodiment;

FIG. 22 is a diagram of an example of the initial screen of the thumbnail list display screen according to the second embodiment;

FIG. 23 is a block diagram of an example of a configuration of a thumbnail generating section according to a third embodiment of the present invention;

FIG. 24 is a flowchart of a process for generating a thumbnail list view of a thumbnail list display screen performed by a server according to the third embodiment;

FIG. 25 is a block diagram of a hierarchical coding process in JPEG2000 part 1 (hereinafter, “JPEG2000”);

FIG. 26 is a schematic diagram for explaining a relationship between decomposition levels and resolution levels;

FIG. 27 is a diagram of relationships among tiles, precincts, and code blocks associated with a wavelet coefficient of a tile;

FIG. 28 is a diagram of a bit-plane;

FIG. 29 is a diagram of an overall code stream formed by a layer progression in JPEG2000;

FIG. 30 is a schematic diagram of a progressive sequence in a layer, resolution, component, position (LRCP) progression (referred to, hereinafter, as a layer progression);

FIG. 31 is a schematic diagram of a progressive sequence in a resolution, layer, component, position (RLCP) progression or a resolution, position, component, layer (RPCL) progression (hereinafter, “resolution progression”);

FIG. 32 is a block diagram of an example of a configuration of a thumbnail generating section according to a fourth embodiment of the present invention; and

FIG. 33 is a diagram of an example of image sizes of thumbnail images that can be generated by a first hierarchically coded thumbnail and a second hierarchically coded thumbnail being respectively decoded according to the fourth embodiment.

### DETAILED DESCRIPTION OF THE PREFERRED EMBODIMENTS

Exemplary embodiments of the present invention are below described with reference to the attached drawings.

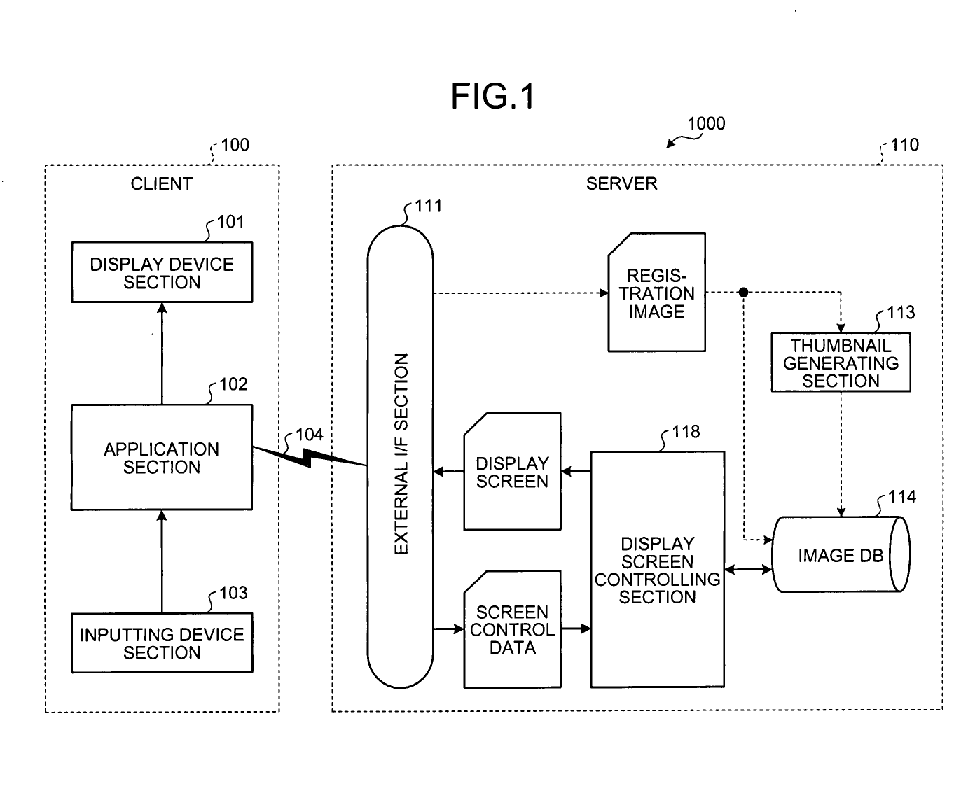

FIG. 1 is a block diagram of a configuration of an image processing system 1000 according to a first embodiment of the present invention. In the image processing system 1000, a client 100 and a server 110 are connected by an external communication path 104. The client 100 is an information processing device, such as a personal computer, a personal digital assistant (PDA), or a mobile phone. The server 110 is an information processing device such as a personal computer. The external communication path 104 is a network, such as a local area network (LAN), an intranet, Ethernet (registered trademark), or the Internet.

A functional configuration of the client 100 will be described. The client 100 includes a display device section 101, an application section 102, and an inputting device section 103. The display device section 101 displays an image. The inputting device section 103 receives input of instructions from a user. The application section 102 includes an application program, or a plurality of application programs, that interprets the instructions, controls communication with the server 110, controls display performed by the display device section 101, and the like based on the interpretation of those instructions.

Next, a functional configuration of the server 110 will be described. The server 110 includes an external interface (I/F) section 111, a thumbnail generating section 113, an image DB 114, and a display screen controlling section 118. The external I/F section 111 controls communication of the server 110 with an external device, such as the client 100. The thumbnail generating section 113 generates thumbnail images from images (registration images) received through the external I/F section 111 and stores the generated thumbnail images in the image DB 114. The image DB 114 stores therein the registration images received through the external I/F section 111 and the thumbnail images generated by the thumbnail generating section 113. The display screen controlling section 118 generates a display screen to be displayed by the client 100. The display screen controlling section 118 controls the display screen by a display screen based on screen control data received from the client 100 via the external I/F section 111. The screen control data is information related to the generation of a display screen, including display magnification indicated by the user, information designating a display area, and the like.

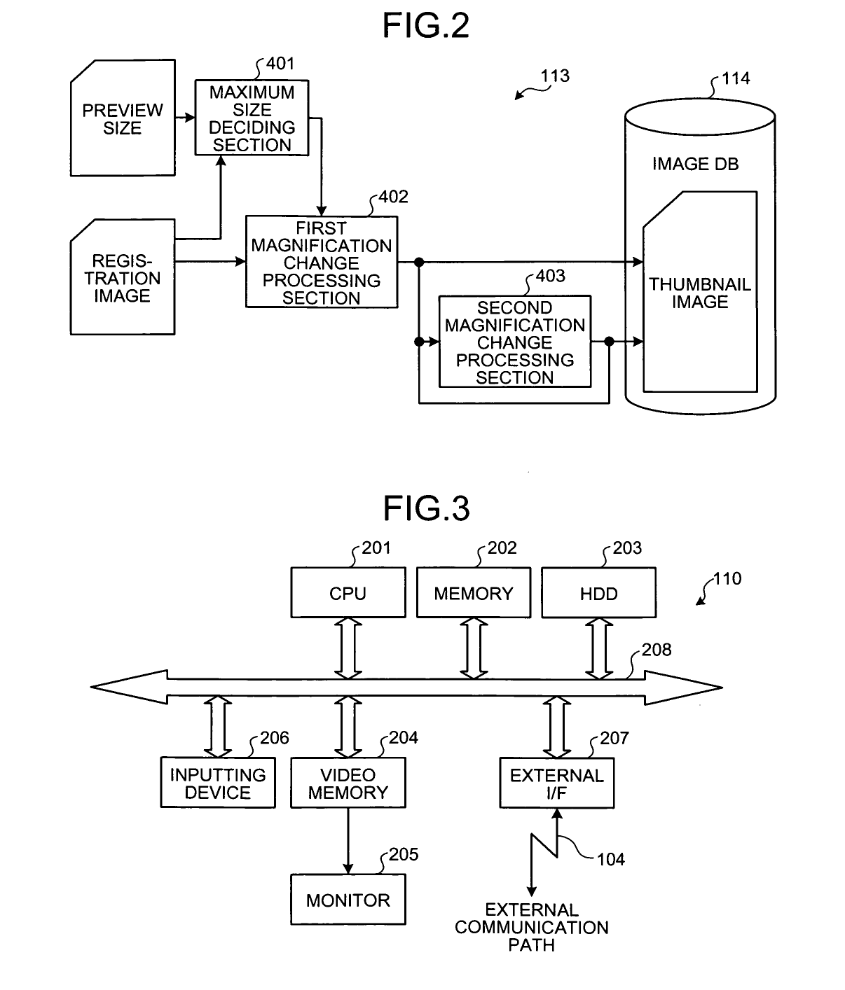

A detailed functional configuration of the thumbnail generating section 113 will be described. FIG. 2 is a block diagram of the detailed functional configuration of the thumbnail generating section 113 and the image DB 114. The thumbnail generating section 113 includes a maximum size deciding section 401, a first magnification change processing section 402, and a second magnification change processing section 403. Based on a preview size (standard display size) set in advance and an image size of an image (registration image) registered in the image DB 114, the maximum size deciding section 401 decides a image size (maximum size) of the largest thumbnail image generated from the registration image. The first magnification change processing section 402 generates the thumbnail image of the maximum size by changing a magnification of the registration image to the maximum size decided by the maximum size deciding section 401. The first magnification change processing section 402 sends the generated thumbnail image to the second magnification change processing section 403 and also stores the generated thumbnail image in the image DB 114. The second magnification change processing section 403 further changes the magnification of the thumbnail image, changed by the first magnification change processing section 402, by vertically and horizontally reducing the thumbnail image by one-half and generates a new thumbnail image. The second magnification change processing section 403 stores the generated thumbnail image in the image DB 114.

Next, a hardware configuration of the server 110 will be described. FIG. 3 is a block diagram of the hardware configuration of the server 110. The server 110 includes a central processing unit (CPU) 201, a memory 202, a HDD 203, a video memory 204, a monitor 205, an inputting device 206, and an external I/F 207. The CPU 201, the memory 202, the HDD 203, the video memory 204, the monitor 205, the inputting device 206, and the external I/F 207 are connected by a communication bus 208. The CPU 201 runs computer programs stored in the memory 202 and the HDD 203 thereby realizing various processes. The memory 202 is a volatile memory that temporarily stores data, such as computer program codes and encoded image data. The HDD 203 stores various pieces of data, such as image data, and various computer programs. The HDD 203 also stores therein the image DB 114. The functions of the thumbnail generating section 113 are actualized by the CPU 201 by running the computer programs stored in the HDD 203 and the memory 202. The external I/F 207 controls transmission and reception of data to and from the client 100 and actualizes the function of the external I/F section 111.

Next, a hardware configuration of the client 100 will be described. The hardware configuration of the client 100 is similar to the hardware configuration of the server 110. Therefore, drawings and detailed explanations thereof are omitted. The client 100 includes a CPU, a memory, a HDD, a video memory, a monitor, an inputting device, and an external I/F. The CPU, the memory, the HDD, the video memory, the monitor, the inputting device, and the external I/F are connected by a communication bus. The HDD of the client 100 stores various pieces of data, such as image data, and various programs. The memory temporarily stores data, such as program codes and encoded image data. The memory and the HDD actualize the function of the application section 102. The monitor actualizes the function of the display device section 101. The inputting device actualizes the function of the inputting device section 103.

Next, operations performed in the image processing system 1000 will be described. The operations are largely separated into two operations: registering images in the image DB 114 and using the images stored in the image DB 114. First, the former operation, i.e., an image registration operation, will be described.

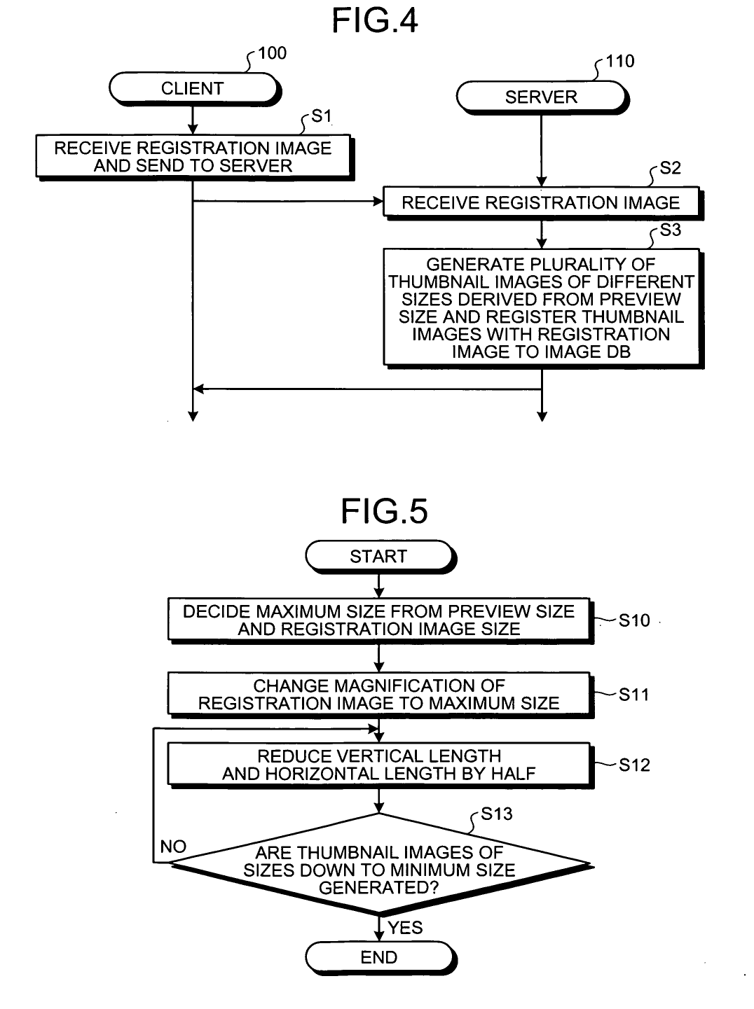

FIG. 4 is a flowchart of an image registration operation. First, the user inputs an instruction via the inputting device section 103, instructing the client 100 to register an image. The user also designates the image to be registered (registration image). The application section 102 of the client 100 then transmits the designated registration image and a message containing an instruction for registration of the image to the server 110 (Step S1). Before transmitting the registration image to the server 110, the application section 102 adds a file name, metadata, and the like to the registration image. Upon receiving the registration image and the message via the external communication path 104 (Step S2), the server 110 adds an identifier (ID) to the registration image and registers the registration image to the image DB 114 along with the file name, the metadata, and the like in the registration image (Step S3). Specifically, the thumbnail generating section 113 of the server 110 generates a plurality of thumbnails of different sizes using the registration image received from the client 100. The sizes are derived from a preview size that is set in advance. The server 110 adds an ID to the generated thumbnail images and registers the thumbnail images to the image DB 114. When the registration image includes a plurality of pages, the server 110 generates the thumbnail images in page units. A process for generating the thumbnail images will be described hereafter.

Details of the process for generating the thumbnail images at Step S3 will be described here. FIG. 5 is a flowchart of the process for generating thumbnail images performed by the server 110 using the function of the thumbnail generating section 113.

The server 110 decides the maximum size of the thumbnail image based on the preview size (standard display size) set in advance and the image size (width and height) of the image (registration image) received from the client 100 (Step S10). The preview size is an image size set in advance, and it is generally smaller than a display area size of the display device of the client 100. The preview size is set to a size allowing the user to decipher text in the image. A value of the size is stored in advance, for example, in the memory 202 and the HDD 203 of the server 110. The maximum size is determined using a size of a long side of the registration image. The long side is the longer of the width and the height of the registration image. For example, the maximum size is the preview size multiplied by a power-of-two (such as two-times or four-times) that is smaller than the size of the long side and is a size closest to the size of the long side. When the size of the long side of the registration image is smaller than the preview size, a size that is smaller than the size of the long side and is one divided by a power-of-two of the preview size (such as ½ or ¼) is the maximum size.

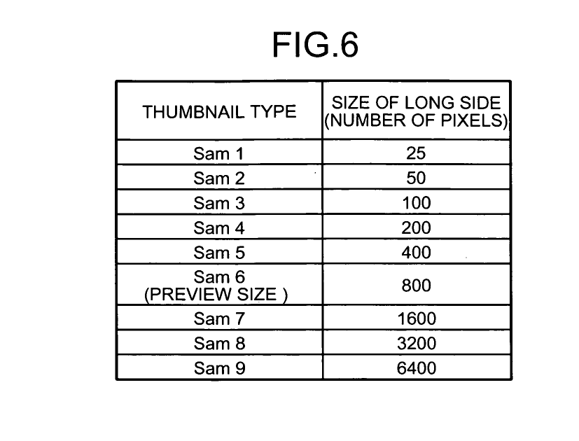

FIG. 6 is a diagram of an example of the preview size and the thumbnail sizes. The sizes are in pixel units. For example, the preview size is “800” and a potential value of the size of the long side of the thumbnail image is “25” to “6400”. Here, when the image size of the registration image has a height of “4000” and a width of “2000”, the height “4000” serves as the size of the long side. The size smaller than the size of the long side and closest to the size of the long side is “3200”. Therefore, “3200” is the maximum size. In other words, the largest thumbnail image is an image with a height of “3200”. A minimum size of the long side of the thumbnail image is “25”.

After the maximum size is decided in this manner, the server 110 changes the magnification of the registration image to an image of which the size of the long side is the maximum size by storing an aspect ratio of the registration image (Step S11). The server 110 then generates the maximum size thumbnail image. In the example in FIG. 6, a thumbnail image of a thumbnail type “Sam 8” is generated. Next, the server 110 reduces the height and width (vertical length and horizontal length) of the maximum size thumbnail image by half. The server 110 then outputs the reduced thumbnail image as a thumbnail image of a different size (Step S12). In the above-described example, a thumbnail image of a thumbnail type “Sam 7” is generated. Next, the server 110 judges whether generation of thumbnail images of sizes down to the minimum size thumbnail image (“Sam 1” in FIG. 6) has been completed (Step S13). When the server 110 judges that the generation of the thumbnail images has not been completed, the server 110 repeats the procedures at Step S12 and Step S13. In the above-described example, the thumbnail images of the thumbnail types “Sam 6” to “Sam 1” are sequentially generated. When the server 110 judges at Step S13 that the generation of the thumbnail images is completed, the process is completed. The generated thumbnail images are registered to the image DB 114 as described above.

An example in which the image sizes of the thumbnail images are set based on pixel count is described above. However, the image sizes of the thumbnail images can be set based on resolution. A plurality of thumbnail images having different resolutions can be generated in the same manner as described above.

Next, the operation of using the images stored in the image DB 114 will be described. In order to use the images, first it is necessary to retrieve a desired image. Using the image refers to the client 100 displaying the image found as a result of the search, or the client 100 downloading the image from the server 110. Various known technologies can be used to retrieve an image. For example, a search can be performed using a keyword. Alternatively, a search can be performed using a similar image. Here, to simplify explanation, an operation for retrieving a desired image from a thumbnail list will be described. The operation can be performed after a few candidate images are retrieved using a keyword or a similar image.

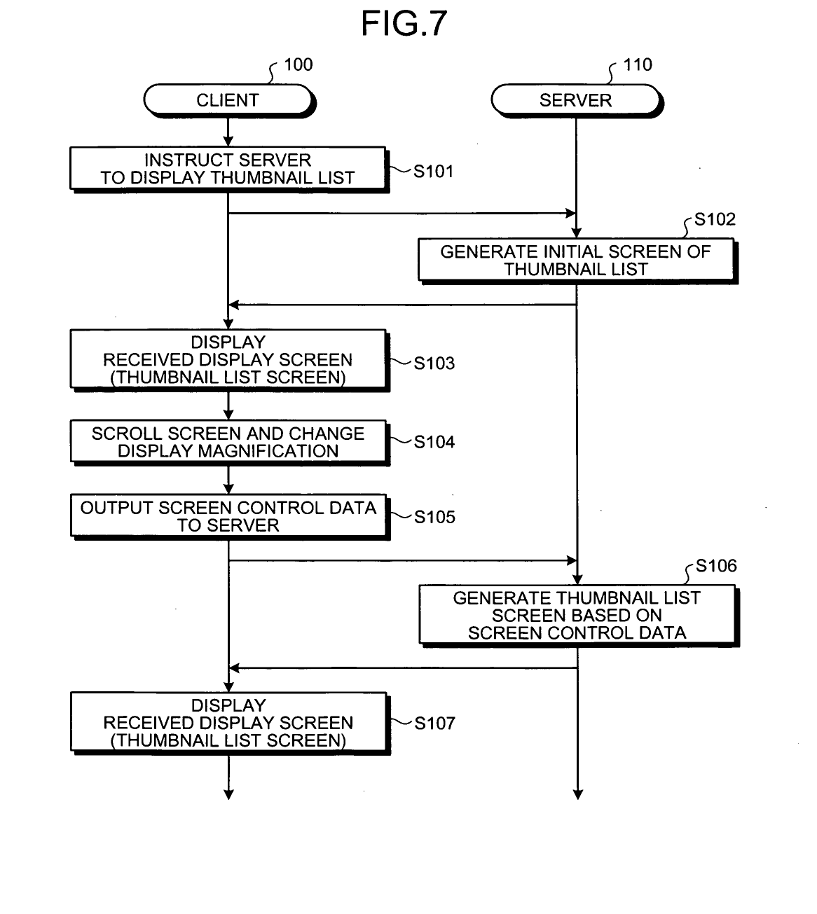

Next, an image retrieval operation according to the first embodiment will be described. FIG. 7 is a flowchart of the image retrieval operation according to the first embodiment. The user inputs an instruction instructing the client 100 to display a thumbnail list, using the function of the inputting device section 103. The client 100 transmits a message containing an instruction for the thumbnail list be displayed to the server 110 using the function of the application section 102 (Step S101). When the server 110 receives the message, the server 110 generates an initial screen of a thumbnail list display screen using the function of the display screen controlling section 118.

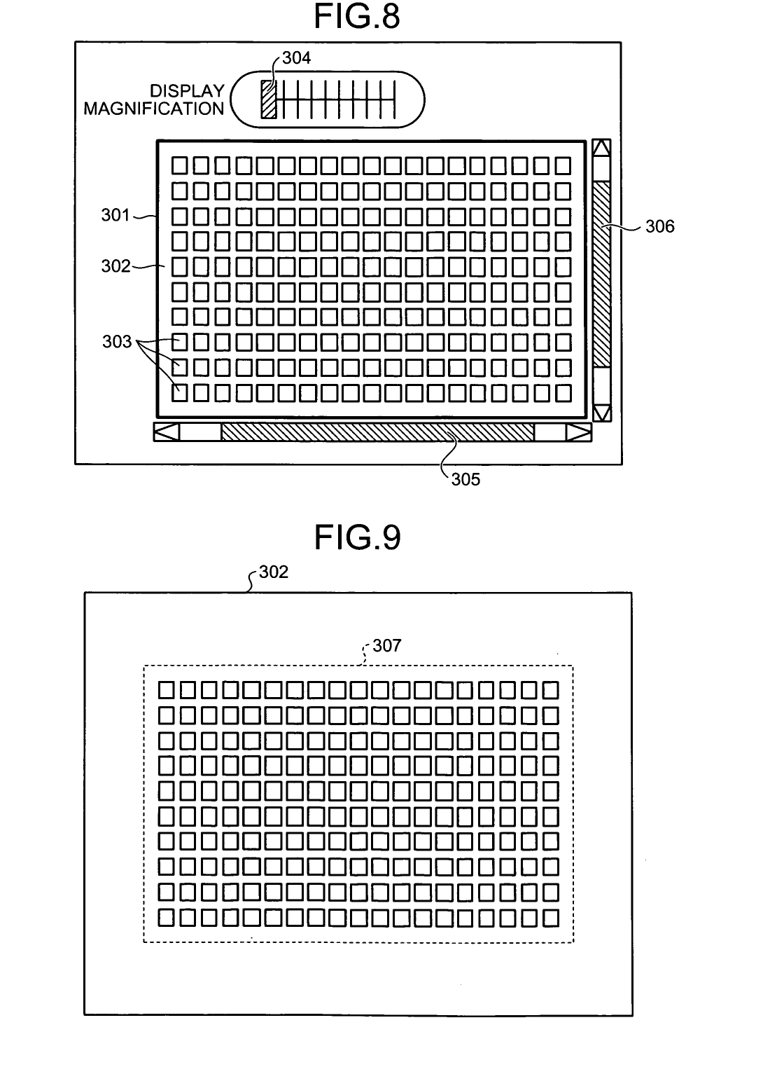

FIG. 8 is an example of an initial screen of a thumbnail list display screen. Constituent elements of the initial screen of the thumbnail list display screen are as follows. A reference number 302 indicates a thumbnail list view that is a display frame for the thumbnail images. A reference number 301 indicates a window restricting a display area of the thumbnail list view 302. A reference number 303 indicates individual thumbnail images. A reference number 304 indicates a slider used to set a display magnification of the thumbnail list view 302. A reference number 305 indicates a slider used to scroll the thumbnail list view 302 in a horizontal direction. A reference number 306 indicates a slider used to scroll the thumbnail list view 302 in a vertical direction.

FIG. 9 is a diagram of the thumbnail list view 302. A reference number 307 indicates a display area indicating a border of the window 301.

The thumbnail list display screen such as this basically has a two-screen structure. One screen is the thumbnail list view 302 and the other screen is user interface sections excluding the thumbnail list view 302 and an outer frame section having significance in terms of design. The other screen is equivalent to the display area outside of the reference number 307 in FIG. 9. The client 100 combines the two screens using the function of the application section 102 and generates a display screen to be displayed on the monitor. The client 100 ultimately generates a display screen (thumbnail list display screen) such as that shown in FIG. 8.

When the server 110 generates the thumbnail list display screen using the function of the display screen controlling section 118, the server 110 generates two types of frames. Any available technology can be used to generate the outer frame section. Therefore, explanations thereof are omitted. When the server 110 generates the initial screen for the thumbnail list display screen, the server 110 sets the display magnification (set to lowest magnification in the diagram) of the thumbnail list view 302 to a predetermined value. The server 110 also sets the size of the display area 307 to a predetermined size. The server 110 generates the initial screen of the thumbnail list view 302. The server 110 then transmits the generated initial screen of the thumbnail list view 302 and the outer frame section to the client 100, via the outer communication path 104, as display screen information (Step S102).

The server 110 is not required to hold the image of the initial screen of the thumbnail list view 302 itself, such as that shown in FIG. 9. Namely, the server 110 is merely required to hold display area information and ID information of the initial screen. The display area information is used to set the display area for each display image and also serves as position information on each image (display image). The ID information identifies the display images. The display area information required at least one of (A) “coordinate data in the thumbnail list view 302” of two points that are peaks at opposing corners of the display image, and (B) coordinate data of a single point that is a peak or a center of the display image and data on the width and height of the image. Generation of the thumbnail list view 302 other than the initial screen can be performed by the server 110 by changing the display area information depending on the display magnification, based on the initial screen. Regarding the thumbnail list view 302, the server 110 transmits only the screen within the display area 307 to the client 100. Details of the process for generating the thumbnail list view 302 will be described hereafter.

Margins are present on the initial screen shown in FIG. 9. When the display magnification is increased, image center sections are enlarged. Therefore, the margins are required to enlarge the thumbnail images positioned at the edges. Various methods can be used to generate the display screen as described as above.

Various methods can be used as a communication method between the server 110 and the client 100. A commonly used, preferred method is as follows. The server 110 is a web server and uses a technology based on the World Wide Web. Generation of the display image and communication between the server 110 and the client 100 is relatively easy in this method. When this technology is used, the display screen is written in HTML. A common web browser actualizes the function of the application section 102. According to the first embodiment, the sliders (304 to 306) used to scroll to change the display magnification and the display areas are included within the display screen. However, for example, when the inputting device section 103 of the client 100 is a mouse, the function of the sliders can be assigned to the mouse.

Returning to FIG. 7, when the client 100 receives the display screen information from the server 110, the client 100 renders the display screen information using the function of the application section 102 and displays the display screen on the monitor (Step S103). When the display area information of the individual display images in the thumbnail list view 302 and the image sizes of the corresponding thumbnail images that are displayed differ, the magnification of the thumbnail images is adjusted such that the size of the display images within the display area indicated by the display area information and the image size of the thumbnail images are the same.

The user of the client 100 can view the display screen shown on the monitor. To search for the desired image, the user can input instructions to change the display area by operating the slider 305 and the slider 306 and change the display magnification by operating the slider 304. The sliders 304, 305, and 306 can be moved with the inputting device section 103, such as a mouse.

When the client 100 receives an input of an instruction to change the display area and an instruction to change the display magnification using the function of the inputting device section 103 (Step S104), the client 100 transmits the screen control data including the indicated display magnification and the information designating the display area to the server (Step S105).

When the server 110 receives the screen control data, the server 110 changes the thumbnail list view based on the display magnification and display area size included in the screen control data. The server 110 then transmits the display screen information including the changed thumbnail list view to the client 100 (Step S106). The process by which the server 110 changes the thumbnail list view will be described hereafter.

When the client 100 receives the display screen information from the server 110, as at Step S103, the client 100 displays the display screen on the monitor (Step S107). When the user cannot find the desired image in the displayed thumbnail list, the user inputs an instruction to change the display area and an instruction to change the display magnification. The procedures at Step S104 to Step S107 are repeated.

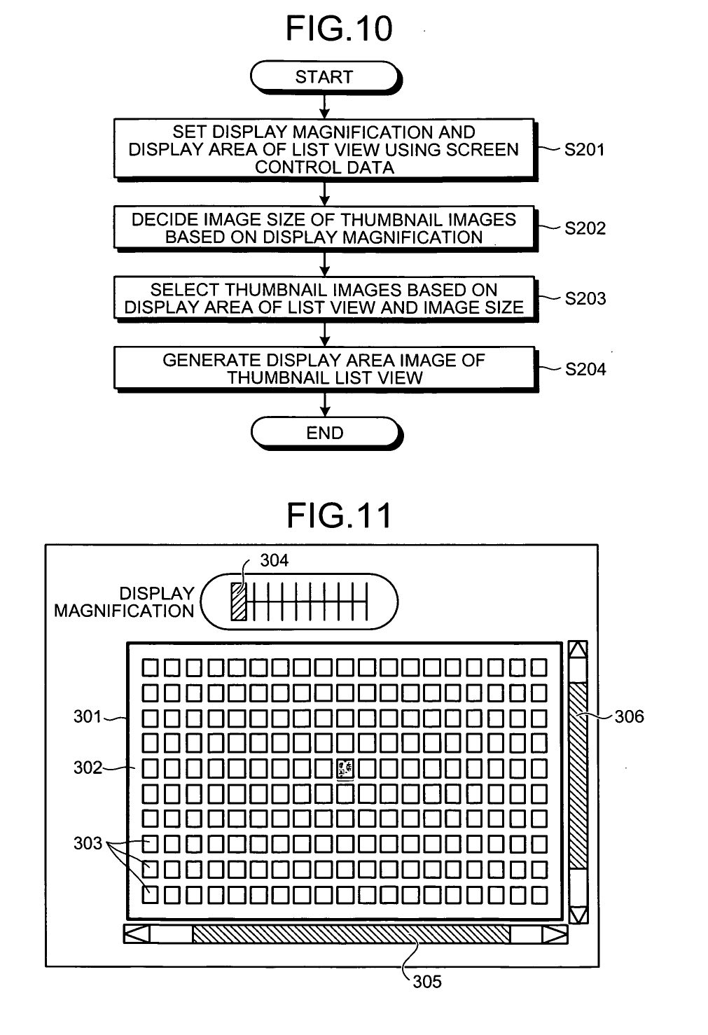

Next, the process for generating the thumbnail list view of the thumbnail list display screen performed by the server 110 will be described. The process also serves as a process for changing the thumbnail list view. FIG. 10 is a flowchart of the process for changing the thumbnail list view performed by the server 110. When the server 110 receives the screen control data transmitted from the client 100 (Step S106 in FIG. 7), the server 100 sets the display magnification and the display area of the thumbnail list view by using the display magnification and the size of the display area included in the screen control data (Step S201). When the initial screen is to be generated, the server 110 sets the display magnification and the display area 307 of the thumbnail list view to predetermined initial values.

Next, the server 110 sets the image size of the thumbnail images used in the display based on the display magnification (Step S202). The server 110 then selects the thumbnail images that correspond to the images included in the display area 307 of the thumbnail list view and have the image size set at Step S202 (Step S203). For example, the image size of any of the thumbnail types “Sam 1” to “Sam 8”, shown in FIG. 6, are set. For example, when the size of the long side of the thumbnail images corresponding to the display magnification is “25”, the thumbnail images of the thumbnail type “Sam 1” are selected.

Instead of actually specifying the display magnification, the user can specify the image size of the thumbnail image itself. The server 110 can select the thumbnail image using the specified image size. When the thumbnail image of the image size matching the image size corresponding to the display magnification is not present, the thumbnail image of an appropriate image size can be selected based on predetermined rules. For example, the thumbnail image of an image size closest to the image size corresponding to the display magnification can be selected. Alternatively, a thumbnail image of an image size smaller than the corresponding image size can be selected (in this instance, amount of data transfer can be reduced).

Next, the server 110 generates the images (display area images) within the display area of the thumbnail list view using the selected thumbnail images (Step S204). The display area images within the thumbnail list view can be generated as bitmap-format data. However, as is commonly used in HTML, a method of writing coordinate information and link information of the images included in the display area image in a structured document is commonly used. In this case, the server 110 is required to transfer the structured document and each thumbnail image included in the display area image to the client 100.

The thumbnail list display screen (display screen) including the thumbnail list view generated as described above is received by the client 100 as the display screen information at Step S107 in FIG. 7. The client 100 renders the display screen information and displays the rendered display screen information on the monitor.

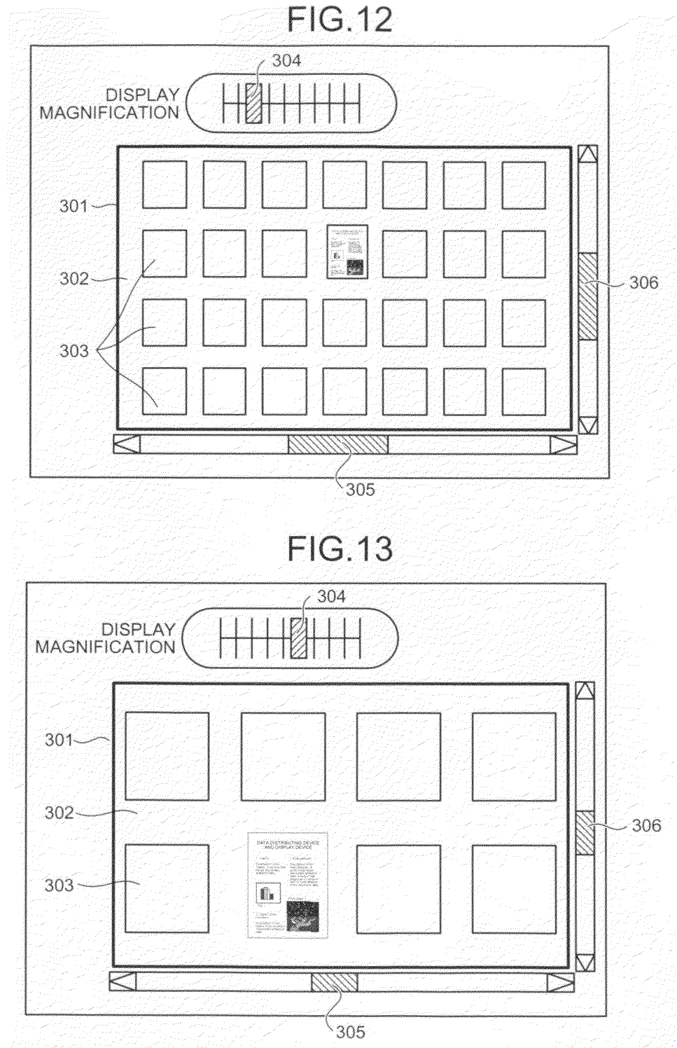

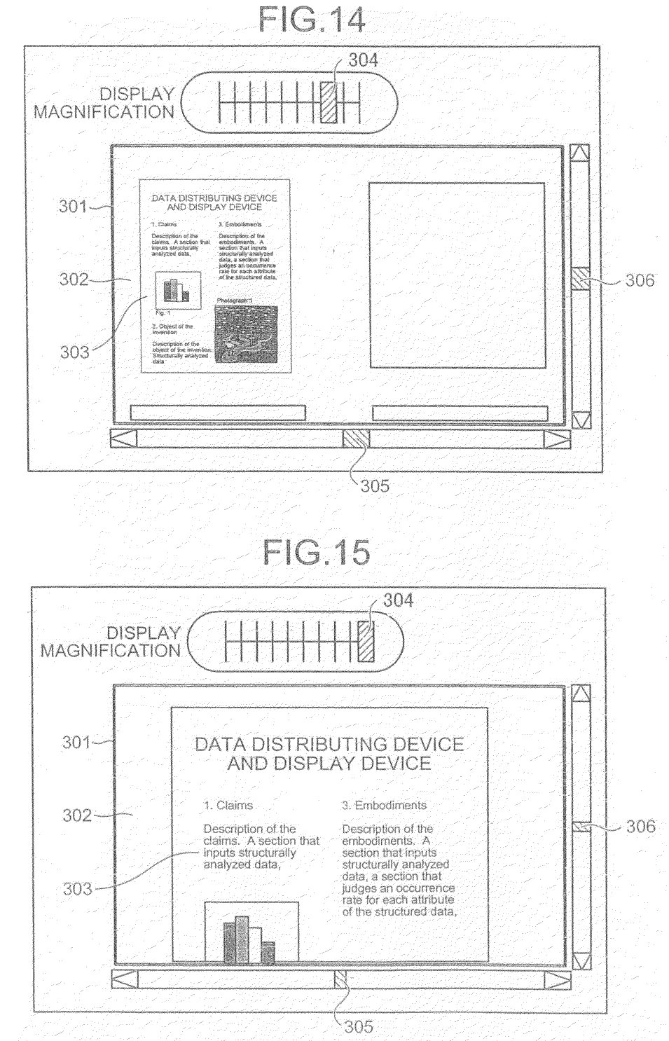

An operation for enlarging the thumbnail images and displaying the enlarged thumbnail images in the thumbnail list display screen displayed on the monitor of the client 100 will be described. FIG. 11 to FIG. 15 are diagrams each showing an example of the thumbnail list display screen shown in a course of an enlarged display the thumbnail images. In particular, FIG. 14 is a diagram of an example of a thumbnail list display screen in which the thumbnail images of the preview size are displayed. On the thumbnail list display screen, the user uses the slider 305 and the slider 306 and displays a candidate image to be retrieved, from among the thumbnail images displayed within the thumbnail list view 302, in the center of the screen (FIG. 11). During a course of gradually increasing the display magnification using the slider 304 (FIG. 12 and FIG. 13), the user can check whether the candidate image is the image to be retrieved while making comparisons with surrounding images and the like and checking the content of the image. When the user recognizes a certain image to be similar to the image to be retrieved, the user may wish to check a detailed layout or briefly read text to make a final confirmation. In this instance, the user uses the slider 305 and the slider 306 and further increases the display magnification from the magnification at FIG. 13. The user displays the preview size thumbnail images in FIG. 14, allowing the user to check the detailed layout and briefly read the text. When legibility of the text is poor at the preview size, the user can enhance legibility by further increasing the display magnification. As shown in FIG. 15, a thumbnail list screen in which the image runs over edges of the thumbnail list view 302 is displayed. In other words, only a portion of the image is displayed in the thumbnail list screen 302. When the user confirms that the image is not the image to be retrieved, the user can reduce the display magnification and searches again for a candidate image to be retrieved. At the same time, when the image is the image to be retrieved, the user can check the details of the content of the image in the state of the thumbnail list view shown in FIG. 15. The preview size is preferably set in advance to a size allowing the user to sufficiently check the layout at the display magnification of the preview size. If the preview size is not set in this way, frequency at which the user changes the display magnification when checking the image increases. Retrieval efficiency may decrease.

In the configuration described above, search can be quickly performed using a function such as the viewer, without opening a separate window. The contents of a plurality of images can be consecutively checked. Definition of the thumbnail images can be changed by the image size of the thumbnail images being changed based on the display magnification. Therefore, the content of the images can be checked without image quality deteriorating every time the display magnification is increased. The preview size is set in advance as the standard display image size. The thumbnail images are generated to be of a size appropriate for the preview size. Therefore, the thumbnail images can be previewed at a size matching with the most significant and most often used display magnification. Moreover, the display size based on the display magnification and the image size of the thumbnail image corresponded one-to-one. As a result, the client 100 is not required to perform the process to change the magnification of the thumbnail images. Therefore, the high quality images can be previewed. When the thumbnail images are listed such as to allow the user to zoom freely, efficiency of image search and productivity during search can be further enhanced.

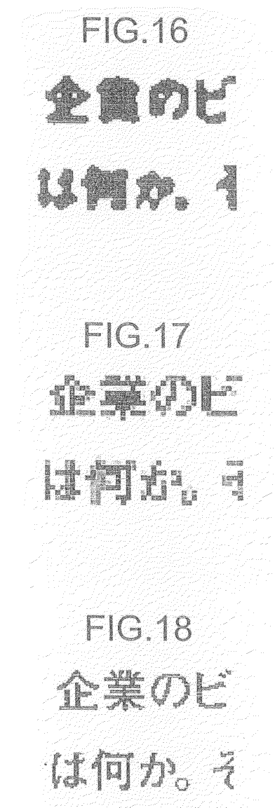

Here, effects according to the first embodiment will be described with reference to FIG. 16 to FIG. 18. FIG. 16 is a diagram of an example of a thumbnail image (image size<display size) when the thumbnail image is enlarged when the thumbnail image is displayed on the monitor of the client 100. FIG. 17 is a diagram of an example of a thumbnail image (image size>display size) when the thumbnail image is reduced. FIG. 18 is a diagram of an example of a thumbnail image (image size and display size correspond one-to-one) when the thumbnail image is neither enlarged nor reduced. FIG. 16 shows that blurring caused by enlargement has occurred. FIG. 17 shows that line breakage and line disappearance (included fading lines) caused by reduction have occurred. In other words, in the images shown in FIG. 16 and FIG. 17, the legibility of the text has clearly decreased compared to the image shown in FIG. 18.

According to the first embodiment, the server 110 holds the thumbnail images in a plurality of different image sizes for each original image. Therefore, when the user briefly checks the content of the images, the server 110 transfers the thumbnail images of the image size matching with the display magnification to the client 100. Therefore, the server 110 is not required to transfer images of an unnecessarily large image size to the client 100. As a result, the amount of data transfer and transfer time required for the user to check the content of the images can be reduced. Productivity during search can be enhanced.

When a thumbnail list display screen including a very large number of thumbnail images is displayed, thumbnail images of an image size smaller than those commonly used can be used. Therefore, the transfer time can be reduced and productivity can be enhanced when the thumbnail images of the smaller image size are transferred. Only the thumbnail images within the display area of the thumbnail list display screen are transferred. Therefore, the transfer time can be shortened and productivity can be enhanced even when thumbnail images of a large image size are transferred.

According to the first embodiment, the image sizes of the thumbnail images other than the preview size are the preview size multiplied by the power-of-two or 1 divided by the power-of-two. However, the image sizes are not limited thereto. However, as a result of the image sizes being limited in this way, the second magnification change processing section 403 is merely required to generate a single pixel from 4×4 pixels. Therefore, configuration is simple. When the second magnification change processing section 403 is actualized by hardware, cost can be reduced. When the second magnification change processing section 403 is actualized by software, processing speed during generation of the thumbnail images can be increased and processing cost can be reduced.

Next, an image processing system 2000 according to a second embodiment will be described. Sections that are the same as those according to the first embodiment are explained using the same reference numbers. Explanations may also be omitted.

According to the first embodiment, arrangement of the thumbnail images are explained without particular limitations. However, when an image is retrieved through the thumbnail list display screen, retrieval efficiency increases when images sharing similar attributes are disposed near each other. Therefore, according to the second embodiment, a classification process for classifying images by the same attributes is performed to enhance retrieval efficiency. Aspects of the classifications are expressed on the screen. For convenience of explanation, the images to be displayed according to the second embodiment are document images often used in offices.

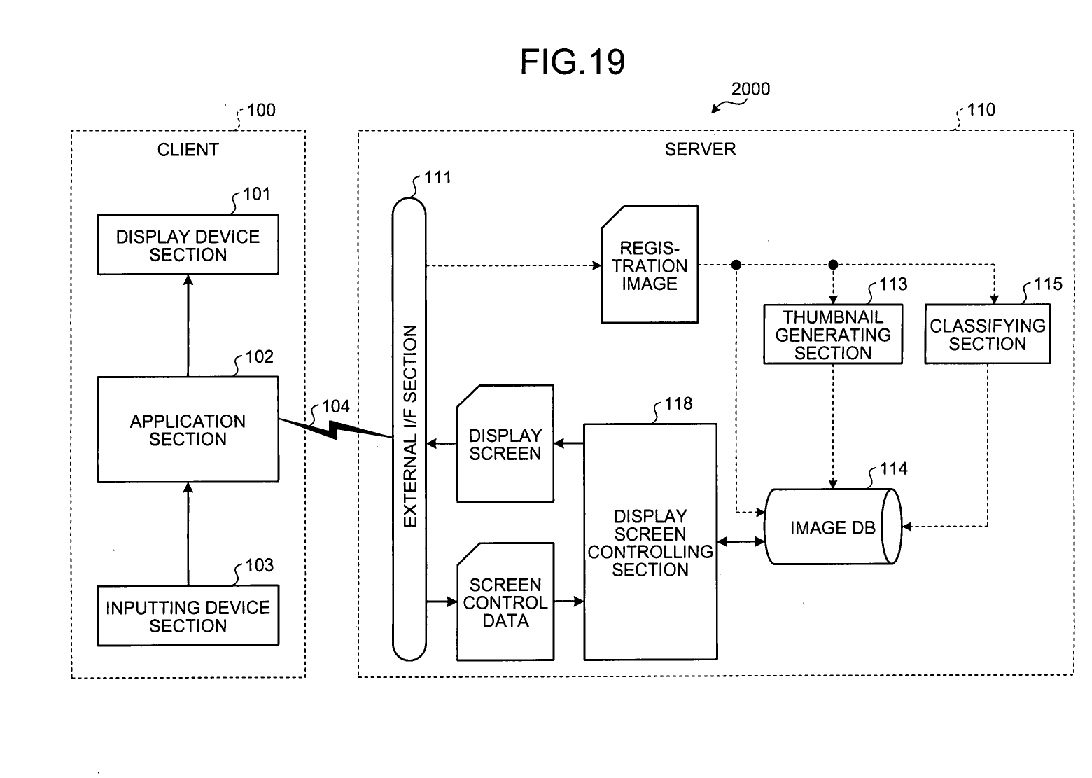

FIG. 19 is a block diagram of a configuration of the image processing system 2000. The configuration of the image processing system 2000 according to the second embodiment differs as follows from the configuration of the image processing system 1000 according to the first embodiment. The server 110 includes a classifying section 115. The classifying section 115 performs the classification process for calculating feature quantity of an image and classifying the image into a predetermined category. Various conventional technologies can be used for document image clustering and the classification process. Here, because the method used to perform the classification process is irrelevant, detailed explanations thereof are omitted. A preferred example of the classification process is, for example, described in Patent Application No. 2006-112912. In a classification processing method described in Patent Application No. 2006-112912, a plurality of feature quantities are calculated from a document image. Based on the feature quantities, a classification process for identifying a category of the image and classifying the image is performed. Types of identified categories are, for example, color, shape, layout, and document type.

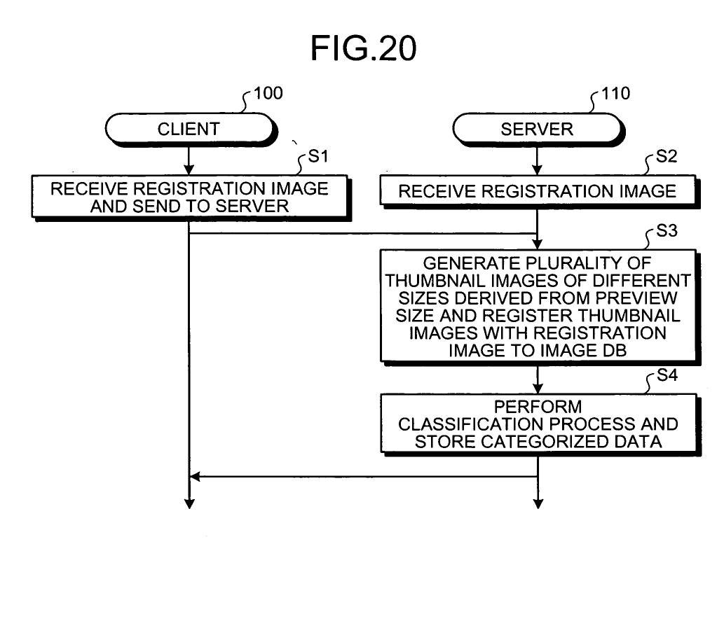

Next, an image registration operation according to the second embodiment will be described. FIG. 20 is a sequence chart of the image registration operation. Step 4 of the image registration operation differs from the image registration operation (FIG. 4) according to the first embodiment. At Step 4, the server 110 calculates the feature quantities from the registration image. Based on the feature quantities, the server 110 performs the classification process for identifying the category of the image and classifying the image. The server 110 then associates category data indicating the identified category with the registration image and registers the category data to the image DB 114. The server 110 also associates the category data with the thumbnail images generated at Step S3 and stored in the image DB 114.

The category identified as described above is used to dispose the thumbnail image in the thumbnail list view 302. For example, at Step S102 in FIG. 7, when the server 110 generates the initial screen of the thumbnail list view 302, the server 110 decides the disposal of each thumbnail image such that the thumbnail images associated with the category data indicating the same category are adjacent to one another. The server 110 then generates the images (display area images) within the display area of the thumbnail list view. For example, during image registration, the server 110 can decide the disposal based on the category of the thumbnail image, hold disposal information (position coordinates of each image on the thumbnail list view) indicating the disposal, and use the disposal information to generate the display area images of the thumbnail list view 302. In this case, processing time required until the thumbnail images are displayed can be decreased.

In the classification process, the server 110 can identify the categories hierarchically. For example, the categories can be identified in levels, such as a broad classification, a middle classification that is subdivided from the broad classification, and a small classification that is subdivided from the middle classification.

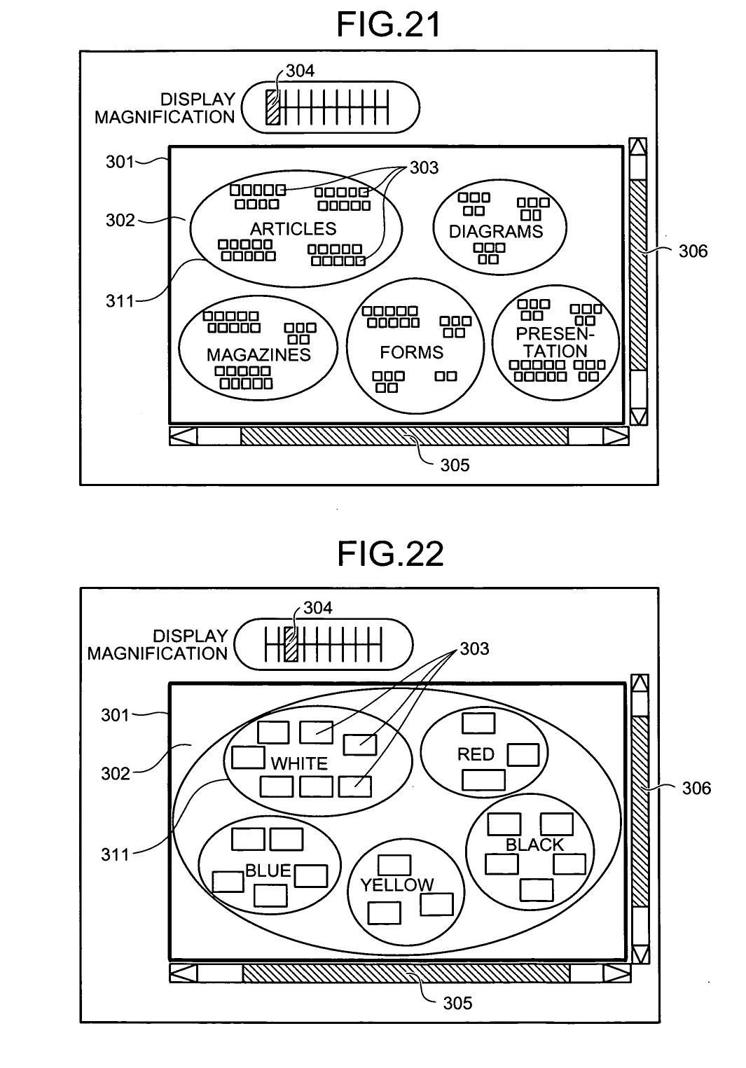

FIG. 21 and FIG. 22 are diagrams of examples of the initial screen of the thumbnail list screen. A reference number 311 in FIG. 21 and FIG. 22 indicates a category border. FIG. 21 is an aspect of the broad classification of the categories, in which the images are classified by document type. FIG. 22 is an aspect of a middle classification of the images classified as “presentation” in FIG. 21, for example, in which the images are classified by color. The color is, for example, classification based a background color of the image. The categories can be further classified by small classifications based on, for example, layout and shape. In FIG. 21 and FIG. 22, a name of each category is displayed as text. However, the name is not required to be displayed.

In this way, the thumbnail images can be collected into categories and the collected thumbnail images can be disposed. The display magnification can be increased without deterioration of image quality. The user can more easily check the images. Images can also be more efficiently retrieved.

When the image size of the thumbnail images in the initial screen of the thumbnail list screen is fixed, the thumbnail images may not fit on a single screen when the number of thumbnail images increases. In this case, in the initial screen, the images can be quasi-expressed by points, colors, pixel density, and the like, instead of the thumbnail images being classified into categories and the classified thumbnail images being disposed.

Next, an image processing system according to a third embodiment will be described. Sections that are the same as those according to the first embodiment and second embodiment are explained using the same reference numbers. Explanations thereof may also be omitted.

According to the first embodiment and the second embodiment, the thumbnail images of different image sizes are generated for each registration image. However, because storage capacity of the image DB 114 is limited, an increase in an amount of data to be stored is not preferable. Therefore, according to the third embodiment, the registered image is compressed by hierarchical coding and the encoded data is stored in the image DB 114.

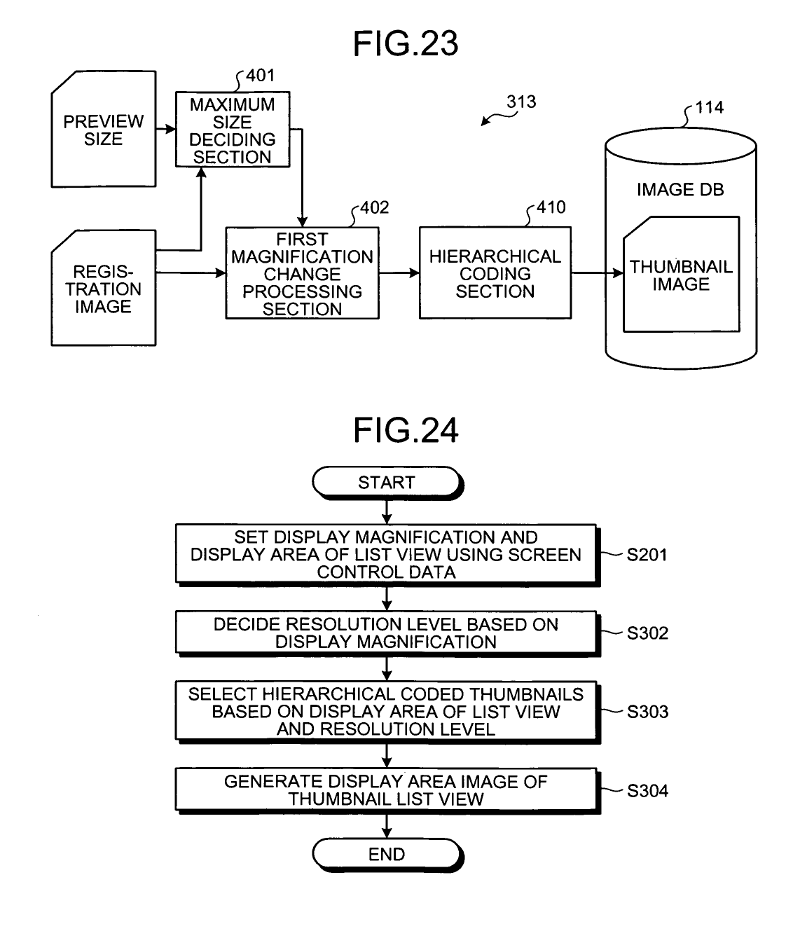

FIG. 23 is a block diagram of an example of a configuration of the thumbnail generating section 313 according to the third embodiment. The thumbnail generating section 313 can be used instead of the thumbnail generating section 113 according to the first and second embodiments. The configuration of the thumbnail generating section 313 according to the third embodiment differs as follows from the configuration of the thumbnail generating section 113 according to the first embodiment. The thumbnail generating section 313 does not include the second magnification change processing section 403. Instead, the thumbnail generating section 313 includes a hierarchical coding section 410. The hierarchical coding section 410 performs hierarchical coding on the maximum size thumbnail images of which the magnification has been changed, generated by the first magnification change processing section 402. According to the third embodiment, the thumbnail images stored in the image DB 114 are only those that have been hierarchically coded. When an entire piece of encoded data of a hierarchically coded thumbnail image (hierarchically coded thumbnail) is decoded, the maximum size thumbnail image is decoded. When a portion of the piece of encoded data of the hierarchically coded thumbnail is decoded, a thumbnail image having a different resolution is decoded. The decoded thumbnail images are 1 divided by a power-of-two (for example, ½ or ¼) of the maximum size. The hierarchical coding process for hierarchically coding the image performed by the hierarchical coding section 410 will be described hereafter.

Next, a process by which the server 110 generates the thumbnail images will be described. According to the third embodiment, the server 110 performs the procedures at Step S10 to Step S11 in FIG. 5. The server 110 then hierarchically codes the maximum size thumbnail images and stores the pieces of encoded data (the hierarchically coded thumbnail) in the image DB 114, without performing the procedures at Step S12 to Step S13.

Next, a process by which the server 110 generates the thumbnail list view of the thumbnail list display screen will be described. FIG. 24 is a flowchart of the process for generating the thumbnail list view of the thumbnail list display screen performed by the server 110. As according to the first embodiment, the server 110 sets the display magnification and the display area 307 of the thumbnail list view in adherence to the screen control data at Step S201. The server 110 then sets a resolution level to be used for the display based on the set display magnification (Step S302). Next, the server 110 selects the hierarchical coded thumbnails stored in the image DB 114 in correspondence with the images included within the display area 307 of the thumbnail list view (Step S303). The server 110 then decodes the hierarchically coded thumbnails selected at Step S303 in adherence to the resolution level set at Step S302 and generates the thumbnail images. The server 110 generates the images (display area images) within the display area of the thumbnail list view (Step S304).

As described above, instead of generating a plurality of thumbnail images of different image sizes, the maximum size thumbnail image is hierarchically coded and thumbnail images of different resolutions are generated by an entire piece of the encoded data or a portion of the piece of encoded data being decoded. As a result, only the encoded data (hierarchically coded thumbnail) of the hierarchically coded maximum size thumbnail images are stored in the image DB 114. Therefore, the amount of data stored in the image DB 114 can be reduced.

Here, the hierarchical coding process performed by the hierarchical coding section 410 will be described. There are numerous conventional technologies used as a hierarchical coding method. The method used according to the third embodiment is not limited. A preferred example is an International Organization for Standardization (ISO) standard IS15444-1 or, in other words, a basic system of Joint Photographic Experts Group (JPEG) 2000 (part 1). Hereafter, an overview of a coding system and progressive sequencing in JPEG2000 part 1 will be described. Refer to IS15444-1 for details.

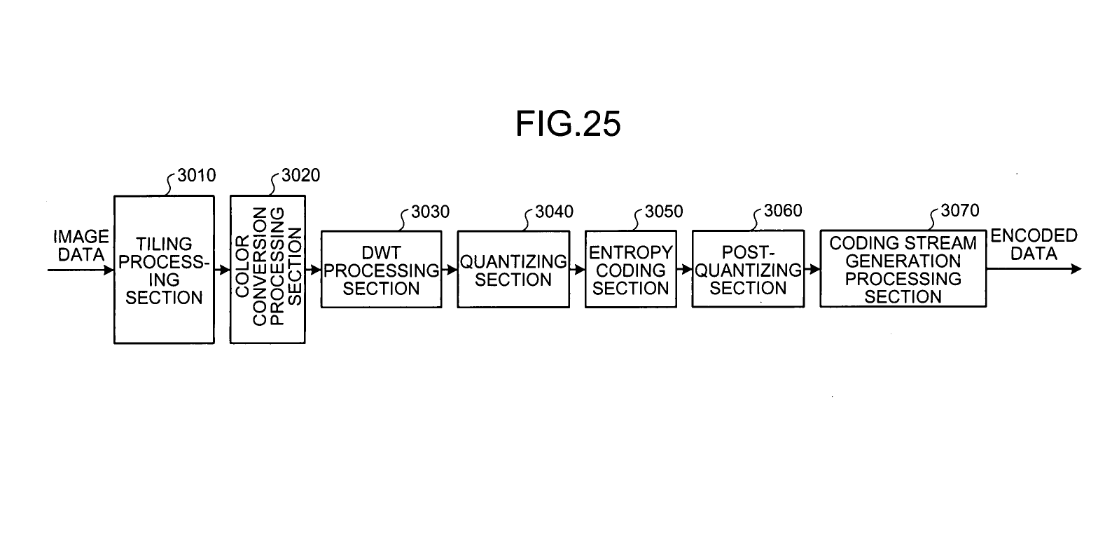

FIG. 25 is a block diagram of the hierarchical-coding process in JPEG2000 part 1 (referred to, hereinafter, as JPEG2000). An example will be described in which inputted image data are colors red, green, and blue (referred to, hereinafter, as RGB). The inputted RGB image data are inputted in rectangular block units called tiles by a tiling processing section 3010. When raster-format image data is inputted, the tiling processing section 3010 performs a raster-to-block conversion. The tiles in JPEG2000 can be encoded and decoded in individual tile units. Encoding and decoding performed using hardware can contribute to multifunctionality in JPEG2000 because, for example, an amount of hardware used can be reduced and decoding and display of only required tiles can be performed. Tiling is an option in JPEG2000. Tiling is arbitrarily performed. However, when tiling is not performed, a tile number is considered to be 1. Next, a color conversion processing section 3020 converts the image data to signals related to luminance and color difference. In JPEG 2000, two types of color conversions are prescribed depending on a type of filter (two types: 5×3 and 9×7) used for discreet wavelet transform (DWT). When, for example, a reversible transform 5×3 filter is used, a reversible color conversion is performed using Equation (1):

$$Y = [ \frac{R + 2 G + B}{4} ] \\ U = R - G \\ V = B - G \qquad ( 1 )$$

where, [x] is a maximum integer that does not exceed x.

Before the color conversion, a direct current (DC) level shift is performed for each red, green, and blue signal. The DC level shift when, for example, the inputted RGB signal is eight bits is shown in Equation (2):

R′=R−128 (2)

A DWT processing section 3030 performs the DWT on each component of the signal after color conversion is performed. A wavelet coefficient is outputted. The DWT is performed two-dimensionally. However, ordinarily, DWT is performed by convolution of a one-dimensional filter calculation using a calculation method called a lifting operation. A one-dimensional conversion formula is shown in Equation (3):

$$L ( k ) = x ( 2 k ) + \frac{H ( k ) + H ( k + 1 )}{4} \\ H ( k ) = x ( 2 k - 1 ) - \frac{x ( 2 k ) + x ( 2 k - 2 )}{2} \qquad ( 3 )$$

where, L(k) is a low frequency component, H(k) is a high frequency component, and-K is a coordinate.

The DWT is accompanied by downsampling. Therefore, resolutions of L(k) and H(k) are half that of the inputted image.

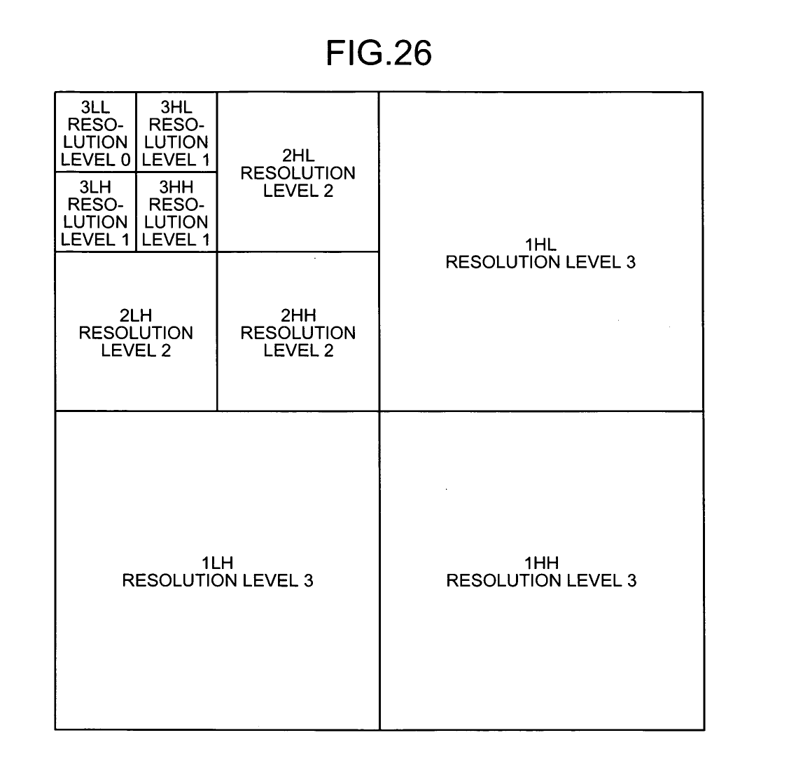

FIG. 26 is a schematic diagram of a relationship between decomposition levels and resolution levels. In the DWT, four direction components referred to as sub-bands are outputted for each decomposition level 1. The four sub-bands are LL, HL, LH, and HH. As a result of the DWT being recursively performed on LL, the decomposition level is increased to a lower resolution. The coefficients of the decomposition level 1 with the highest resolution are expressed as 1HL, 1LH, and 1HH. Subsequent levels are expressed as 2HL, 2LH, and so on, to nHH. FIG. 26 also shows an example of a division into a decomposition level 3. At the same time, resolution levels are referred to as 0, 1, 2, and 3, starting from a coefficient with the lowest resolution, progressing in an opposite direction of the decomposition levels.

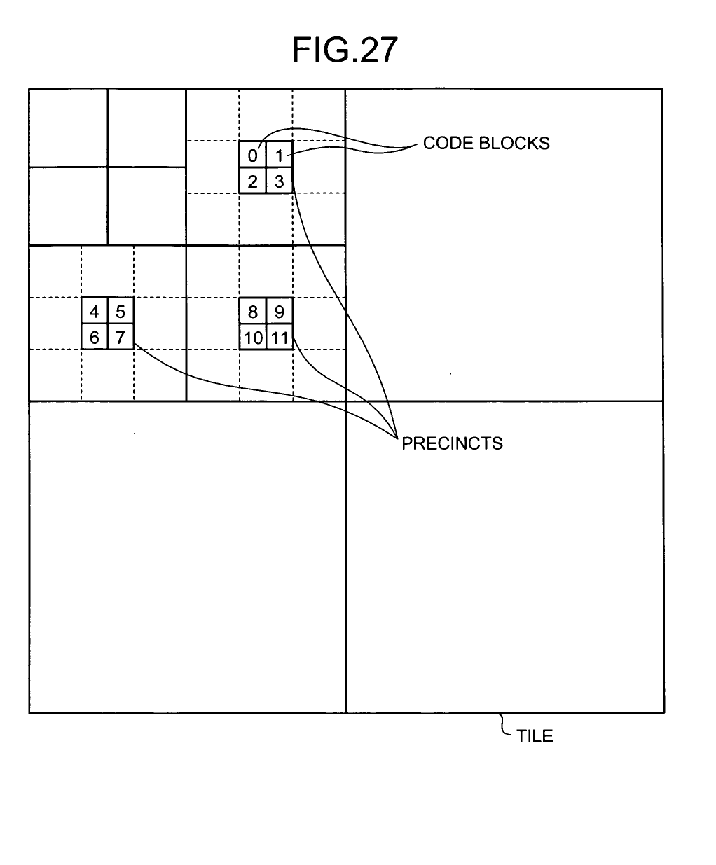

The sub-band at each decomposition level can be divided into areas called precincts and a group of codes can be formed. Coding is performed in predetermined block units called code blocks. FIG. 27 is a diagram of a relationship between tiles, precincts, and code blocks associated with the wavelet coefficient within a tile.

A quantizing section 3040 performs scalar quantization on the wavelet coefficient outputted from the DWT processing section 3030. However, when the reversible conversion is performed, the scalar quantization is not performed or the wavelet coefficient is quantized by “1”. Effects similar to quantization can be achieved in a latter stage post-quantization. In the scalar quantization, parameters can be changed in tile units.

An entropy coding section 3050 performs entropy coding on the quantized data outputted from the quantizing section 3040. An entropy coding system in JPEG2000 divides the sub-band into rectangular areas referred to as code blocks (however, when a size of the sub-band is smaller than the code block, the sub-band is not divided) and encodes data in code block units.

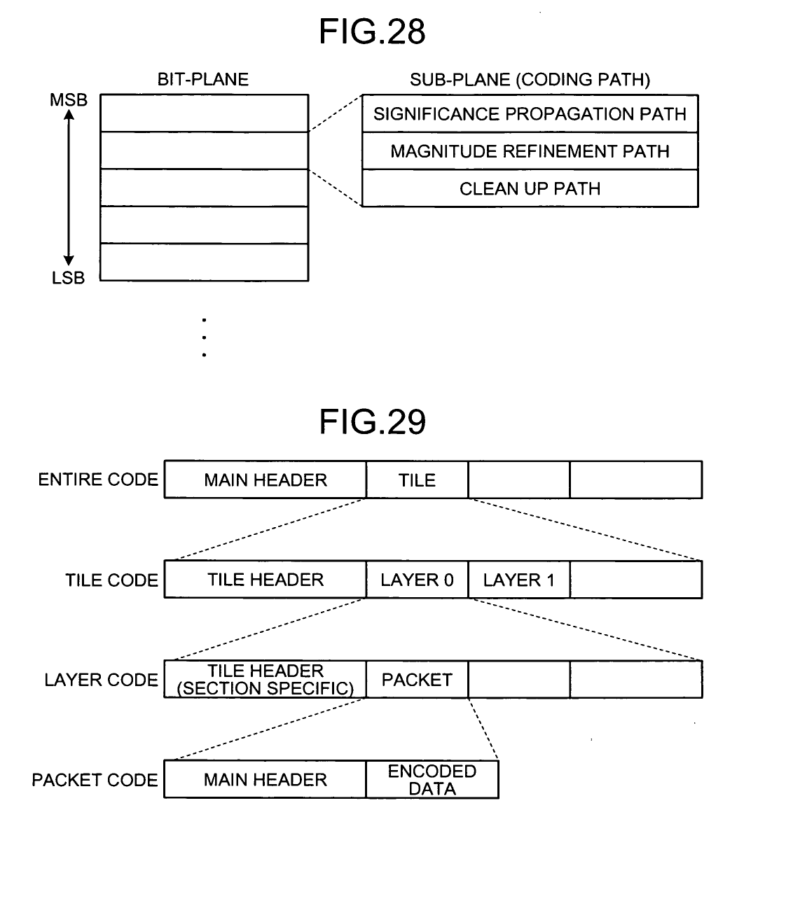

FIG. 28 is a diagram of a bit-plane. After data within the code block is decomposed into bit-planes as shown in FIG. 28, the bit-plane is divided into three paths (a significance propagation path, a magnitude refinement path, and a clean-up path) in adherence to a state indicating a degree of effect a conversion coefficient has on image quality. At each path, data is encoded by an arithmetic coding system referred to as an MQ coder. The bit-plane on a most significant bit (MSB) side has a highest significance (in terms of contribution to image quality). Significance of the coding paths increase in order of the significance propagation path, the magnitude refinement path, and the clean-up path. An end of each path is also referred to as a truncation point. The truncation point is a unit of code that can be truncated when the post-quantization is performed at the latter stage.

A post-quantizing section 3060 truncates the entropy-coded data as required. When a reversible code is required to be outputted, the post-quantization is not performed. Because an amount of codes can be truncated after encoding is performed, the JPEG2000 has a configuration (encoding of a single path) that does not require feedback to control the amount of codes. A code stream generation processing section 3070 rearranges the codes in the encoded data after post-quantization in adherence to a predetermined progressive sequence (decoding sequence for the encoded data) and adds a header. A code stream of a tile is completed.

FIG. 29 is a diagram of an overall code stream formed by a layer progression in JPEG2000. An entire code includes a plurality of tiles dividing a main header and the images. A tile code includes a plurality of layers. The layers are code units (described in detail hereafter) into which a tile header and codes within the tile are separated. The layers are sequentially aligned from low-order layers, such as layer 0, layer 1, and so on. A layer code includes a tile header for the layer and a plurality of packets. The packet includes a packet header and the encoded data. The packet is the smallest unit of the encoded data. The packet is formed by the encoded data of a single layer within a single precinct in a single resolution level (decomposition level), within a single tile component.

Next, the progressive sequence in the JPEG2000 will be described. In the JPEG2000, five progressions, described below, are prescribed by changes in priority among four image elements: image quality (layer [L]), resolution (R), component (C), and position (precinct [P]).

(a) LRCP progression

Decoding is performed in order of precinct, component, resolution level, and layer. Therefore, the image quality of the overall image can be improved every time a layer index advances. An image quality progression can be actualized. This progression is also referred to as a layer progression.

### (b) RLCP Progression

Decoding is performed in order of precinct, component, layer, and resolution level. Therefore, a resolution progression can be actualized.

### (c) RPLC Progression

Decoding is performed in order of layer, component, precinct, and resolution level. Therefore, like RLCP, the progression is a resolution level progression. However, priority can be given to a certain position.

### (d) PCRL Progression

Decoding is performed in order of layer, resolution level, component, and precinct. Therefore, priority is given to decoding of a certain portion. A spatial position progression can be actualized.

### (e) CPRL Progression

Decoding is performed in order of layer, resolution level, precinct, and component. A component progression can be actualized. For example, when a color image is progressively decoded, a gray image can be reproduced first.

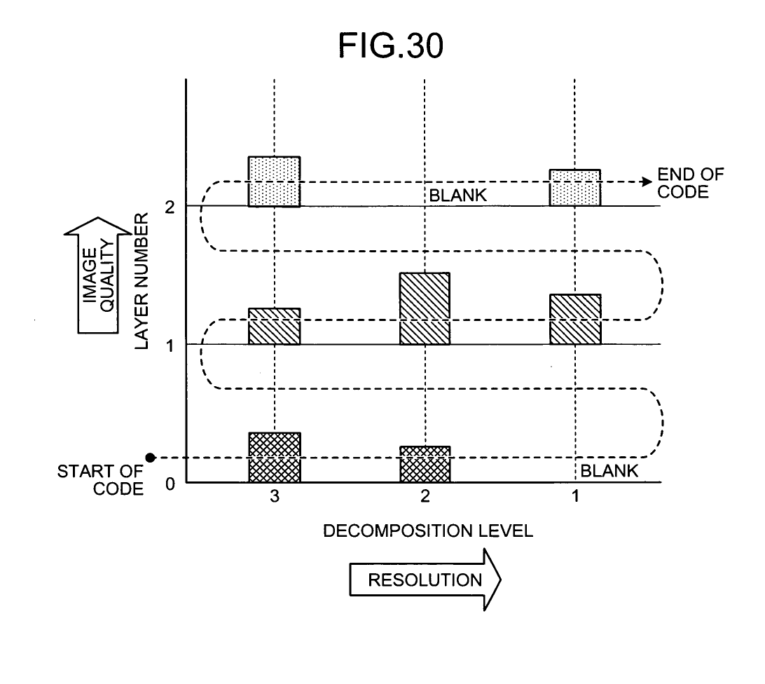

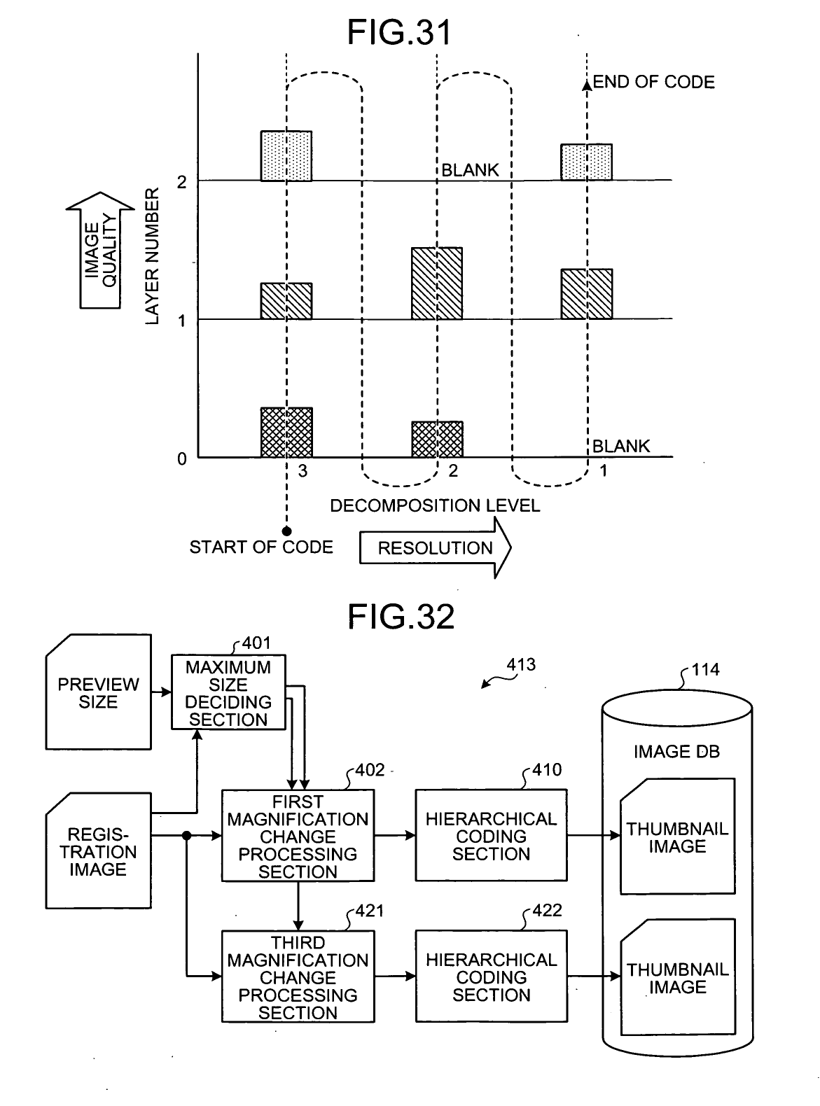

FIG. 30 is a schematic diagram of the progressive sequence of the LRCP progression (hereinafter, “layer progression”). FIG. 31 is a schematic diagram of the progressive sequence of the RLCP progression or the RPCL progression (referred to, hereinafter, as the resolution progression). In FIG. 30 and FIG. 31, a horizontal axis indicates the decomposition level (the higher the number is, the lower the resolution). A vertical axis indicates a layer number (the higher the number is, the higher the layer; a higher quality image can be reproduced by adding a high-order layer code to a low-order layer and decoding the data). Shaded rectangles indicate codes in association with the decomposition level and the layer. A size of the rectangle schematically indicates a proportion of the amount of the code. An arrow with a dotted line indicates an encoding sequence.

FIG. 30 shows the encoding sequence by which decoding is performed based on the layer progression. Decoding is performed on all resolutions of a same layer number. Decoding is then performed for a subsequent high-order layer. In terms of the wavelet coefficient, decoding is performed from a high-order bit of the coefficient. A progression in which the image quality gradually improves can be actualized. FIG. 31 shows the encoding sequence in which decoding is performed based on the resolution progression. Decoding is performed on all layers of a same decomposition (resolution) level. Decoding is then performed for a subsequent decomposition (resolution) level. A progression in which the image quality gradually improves can be actualized.

According to the third embodiment, the registration images are hierarchically coded using a hierarchical coding system represented by JPEG2000, as described above. As a result, the thumbnail images of different resolutions can be generated based on the resolution level of the resolution appropriate for the image size of the thumbnail image at Step S303 in FIG. 24. The examples in FIG. 30 and FIG. 31 have three tiers. However, a number of tiers can be increased. An effect of reduction in the amount of data transfer when a large number of thumbnail images are displayed within the display area 307 of the thumbnail list view increases when the number of tiers increases. The number of tiers is decided as follows. The number of tiers (number of decomposition levels) is decided in correspondence with individual image sizes. An image size of when a resolution level 0 code is decoded is preferably roughly the same as the image size corresponding to the number of tiers.

Next, an image processing system according to a fourth embodiment will be described. Sections that are the same as those according to the first embodiment, second embodiment, and third embodiment are explained using the same reference numbers. Explanations thereof may also be omitted.

According to the third embodiment, the maximum size thumbnail images are hierarchically coded. The encoded data is stored in the image DB 114. However, in a commonly performed hierarchical coding process, the thumbnail image that can be decoded from the encoded data is only the minimum size multiplied by the power-of-two. Therefore, freedom in image size is limited. Deterioration in image quality may occur at an intermediate display size of the image size of the thumbnail image than can be decoded. Therefore, according to the fourth embodiment, the image processing system is configured such that high image quality can be maintained when the thumbnail images are displayed at the preview size while allowing reduction in the amount of data stored in the image DB 114.

FIG. 32 is a block diagram of an example of a configuration of the thumbnail generating section 413 according to the fourth embodiment. The thumbnail generating section 413 can be used instead of the thumbnail generating section 113 according to the first and second embodiments. The configuration of the thumbnail generating section 413 according to the fourth embodiment differs as follows from the thumbnail generating section 313 according to the third embodiment, described above. The thumbnail generating section 413 further includes a third magnification change processing section 421 and a hierarchical coding section 422.

In the same manner as the first embodiment, the maximum size deciding section 401 according to the fourth embodiment decides a first maximum size of the thumbnail image from the preview size (standard display size) set in advance and the image size of the image (registration image) registered to the image DB 114. The maximum image size is outputted to the first magnification change processing section 402. At the same time, the maximum image size deciding section 401 sets a size that is 1.5 times the preview size as a second standard display size. The maximum size deciding section 401 decides a second maximum size of the thumbnail image from the second standard display size and the image size of the registration image. The second maximum size is outputted to the third magnification change processing section 421. The first magnification change processing section 402 changes the magnification of the registration image to the first maximum size and generates a thumbnail image of the first maximum size. The hierarchical coding section 410 hierarchically codes the thumbnail image of the first maximum size and stores the encoded data (first hierarchically coded thumbnail) in the image DB 114. At the same time, the third magnification change processing section 421 changes the magnification of the registration image to the second maximum size and generates a thumbnail image of the second maximum size. The hierarchical coding section 422 hierarchically codes the thumbnail image of the second maximum size and stores the encoded data (second hierarchically coded thumbnail) in the image DB 114.

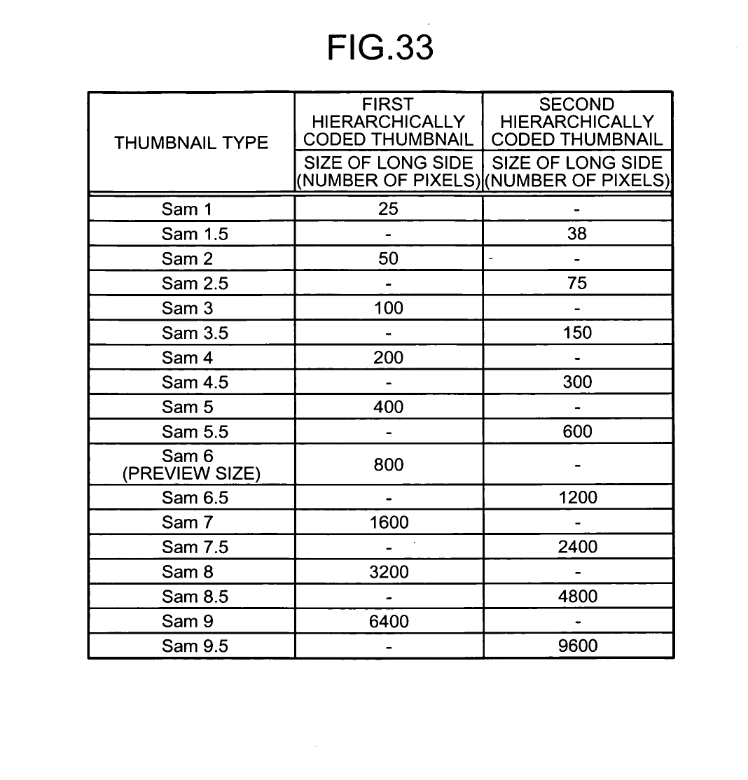

FIG. 33 is a diagram of an example of the image sizes of the thumbnail images that can be generated by a first hierarchically coded thumbnail and a second hierarchically coded thumbnail being respectively decoded. It is clear that a thumbnail image of an intermediate size of the image sizes of the thumbnail image that can be generated from the first hierarchically coded thumbnail can be generated from the second hierarchically coded thumbnail. Therefore, through decoding of either the first hierarchically coded thumbnail or the second hierarchically coded thumbnail in adherence to the display magnification, a thumbnail image having a high image quality in adherence to the display magnification can be displayed.

According to the fourth embodiment, the thumbnail generating section 413 is configured to have two sets of a set including a magnification change processing section and a hierarchical code processing section. However, the thumbnail generating section 413 can have only one set of the magnification change processing section and the hierarchical code processing section and generate two hierarchically coded thumbnails, the first hierarchically coded thumbnail and the second hierarchically coded thumbnail, in a time series. The two hierarchically coded thumbnails, the first hierarchically coded thumbnail and the second hierarchically coded thumbnail, are given as examples. However, more hierarchically coded thumbnails can be generated, increasing variation in the image sizes of the thumbnail image that can be displayed.

In FIG. 33, an example is shown in which the two hierarchically coded thumbnails, the first hierarchically coded thumbnail and the second hierarchically coded thumbnail, are used for extremely small image sizes. However, problems related to image quality deterioration are rare when the image size is extremely small. Therefore, a configuration can be made in which the thumbnails adhering to the display magnification using the second hierarchically coded thumbnail is generated only after the display magnification increases to a certain extent.

In the configuration such as that described above, the image sizes of the thumbnail image that can be displayed can be increased through use of a simple method. A high quality thumbnail image can be displayed with a wider range of display magnification.

The second standard display size is 1.5 times the preview size (standard display size). Therefore, the thumbnail image of the intermediate image size of the image sizes of the thumbnail image that can be generated based on the preview size can be generated through use of a simple method.

The invention is not limited to the above-described embodiments. Various modifications can be made, as described hereafter.

The various computer programs run by the client 100 or the server 110 according each embodiment can be recorded in a form of an installable file or an executable file onto a recording medium that can be read by a computer and the various programs can be provided through the recoding medium. The recording medium is, for example, a compact disc-read only memory (CD-ROM), a flexible disk (FD), a compact disc-recordable (CD-R), and a digital versatile disk (DVD). The various programs can be stored on a computer connected to a network such as the Internet. The various programs can be provided by the programs being downloaded via the network.

Moreover, the registration image registered in the image DB 114 can be directly transmitted to the server 110 from an image inputting device, such as a scanner or a digital camera.

Furthermore, a commonly used relational data base can be used as the image DB 114 to register metadata including the ID and the file name in the image DB and manage the metadata to allow retrieval. Processes, such as compression coding, are performed as required on the registration images that become the thumbnail images and the original images. The processed images are stored in the image DB 114. The image DB 114 can be constructed such that each image can be read by a link from the metadata. The image DB 114 can also be constructed to use a language such as extensible Markup Language (XML) and have a hierarchical data structure and the like. The image DB 114 can be constructed such as to be dispersed over a plurality of servers and held.

According to each embodiment, the maximum size deciding section 401 decides the image size (maximum image size) of the largest thumbnail image generated from the registration image. However, the maximum size deciding section 401 can decide magnification change rate used to generate the largest thumbnail image. The first magnification change processing section 402 can change the magnification of the registration image to a size appropriate for the magnification change rate and generate the largest thumbnail image.

According to an aspect of the present invention, when the thumbnail images are displayed in a list such as to allow the user to zoom freely, efficiency of image search and productivity during search can be further enhanced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device comprising:
a generating section that uses an original image stored in an image storing section to generate a plurality of thumbnail images in image sizes differing from an image size of the original image;
a receiving section that displays an image, which can be at least one of the original image and a thumbnail image, in a display section and receives screen control information indicating a display magnification from an information processing device that receives an input of an instruction to change the display magnification of displayed image;
a screen controlling section that selects a thumbnail image, from among the plurality of thumbnail images generated by the generating section, of an image size matching with the display magnification, contained in the screen control information received by the receiving section, and generates display screen information including selected thumbnail image; and
a transmitting section that transmits the display screen information to the image processing device, wherein
the generating section generates at least a standard thumbnail image of a first standard display size set in advance to be smaller than a size of a display area of the display section.

2. The image processing device according to claim 1, wherein the generating section generates a thumbnail image of an image size that is at least roughly one of the first standard display size multiplied by a power-of-two and one divided by the power-of-two of the first standard display size.

3. The image processing device according to claim 1, wherein the generating section includes
a deciding section that, based on the first standard display size and the image size of the original image, decides one of a maximum image size of the thumbnail to be generated and a maximum magnification change rate;
a first magnification change processing section that changes one of a magnification of the original image to a size appropriate for the maximum image size and the maximum magnification change rate decided by the deciding section and generates a largest thumbnail image; and
a second magnification change processing section that reduces the largest thumbnail image generated by the first magnification change processing section thereby generating a second thumbnail image.

4. The image processing device according to claim 3, wherein the second magnification change processing section reduces the largest thumbnail image using a plurality of different magnification change rates thereby generating a plurality of second thumbnail images.

5. The image processing device according to claim 1, wherein the generating section includes
a deciding section that, based on the first standard display size and the image size of the original image, decides one of a maximum image size of the thumbnail to be generated and a maximum magnification change rate instead of generation of the plurality of thumbnail images in image sizes differing from an image size of the original image;
a first magnification change processing section that changes one of a magnification of the original image to a size appropriate for the maximum image size and the maximum magnification change rate decided by the deciding section and generates a largest thumbnail image; and
a hierarchical coding section that hierarchically codes the largest thumbnail image.

6. The image processing device according to claim 5, wherein the hierarchical coding section hierarchically codes the largest thumbnail image such that, when an entire code or a portion of a code is decoded, a thumbnail image of an image size that is at least roughly one of the first standard display size multiplied by a power-of-two and one divided by the power-of-two of the first standard display size is decoded.

7. The image processing device according to claim 5, wherein the hierarchical coding section hierarchically codes the largest thumbnail image such that, when the entire code or a portion of the code is decoded, thumbnail images of a plurality of image sizes are decoded.

8. The image processing device according to claim 5, wherein the generating section generates a second standard thumbnail image of a second standard display size differing from the first standard display size.

9. The image processing device according to claim 8, wherein the deciding section decides one of the maximum image size and the maximum magnification change rate and, based on the second standard display size and the image size of the original image, decides one of a second maximum image size, differing from the maximum image size or the maximum magnification change rate, and a second maximum magnification change rate;
the first magnification change processing section generates the maximum thumbnail image, and changes the magnification of the original image to a size appropriate for the second maximum image size or the second maximum magnification change rate thereby generating a second largest thumbnail image; and
the hierarchical coding section hierarchically codes the maximum thumbnail image and the second maximum thumbnail image.

10. The image processing device according to claim 9, wherein the hierarchical coding section hierarchically codes the largest thumbnail image such that, when an entire code or a portion of a code is decoded, a thumbnail image of an image size that is at least roughly one of the first standard display size multiplied by a power-of-two and one divided by the power-of-two of the first standard display size is decoded, and hierarchically codes the second largest thumbnail image such that, when an entire code or a portion of a code is decoded, thumbnail images of a plurality of image sizes that are at least roughly one of the second standard display size multiplied by a power-of-two and one divided by the power-of-two of the first standard display size can be decoded.

11. The image processing device according to claim 9, wherein the hierarchical coding section hierarchically codes the largest thumbnail image such that, when the entire code or a portion of the code is decoded, thumbnail images of a plurality of image sizes can be decoded and hierarchically codes the second largest thumbnail image such that, when the entire code or a portion of the code is decoded, thumbnail images of a plurality of image sizes can be decoded.

12. The image processing device according to claim 7, wherein the second standard display size is roughly 1.5 times the first standard display size or roughly one divided by 1.5 of the first standard display size.

13. The image processing device according to claim 1, wherein
the generating section stores the generated thumbnail images in the image storing section, and
the screen controlling section selects the thumbnail image of the image size matching with the display magnification indicated by the screen control information from the image storing section when the screen control information is received by the receiving section, and generates the display screen information including the selected thumbnail image.

14. The image processing device according to claim 1, wherein the receiving section receives the original image from the information processing device, and
the image processing device further includes a controlling section that stores the original image received by the receiving section in the image storing section.

15. The image processing device according to claim 14, further comprising a classifying section that analyzes the original image received by the receiving section and classifies the original image in a predetermined category, wherein
the controlling section associates classification information indicating the category to which the original image belongs with the original image and stores the classification information in the image storing section.

16. The image processing device according to claim 15, wherein the controlling section associates the thumbnail image generated by the generating section using the original image and the classification information of the original image and stores the thumbnail image in the image storing section.

17. The image processing device according to claim 1, wherein the image size is expressed by a number of pixels.

18. The image processing device according to claim 1, wherein the image size is expressed by a resolution.

19. An image processing method comprising:
generating, by employing an original image stored in an image storing section, a plurality of thumbnail images in image sizes differing from an image size of the original image;
displaying in a display section an image, which can be at least one of the original image and a thumbnail image;
receiving screen control information indicating a display magnification from an information processing device that receives an input of an instruction to change the display magnification of displayed image;
selecting a thumbnail image, from among the plurality of thumbnail images generated at the generating, of an image size matching with the display magnification, contained in the screen control information received at the receiving, and generating display screen information including selected thumbnail image; and
transmitting the display screen information to the image processing device, wherein
the generating includes generating at least a standard thumbnail image of a first standard display size set in advance to be smaller than a size of a display area of the display section.

20. A computer program product that includes computer program codes stored on a computer readable recording medium that when executed on a computer enables the computer to execute:
generating, by employing an original image stored in an image storing section, a plurality of thumbnail images in image sizes differing from an image size of the original image;
displaying in a display section an image, which can be at least one of the original image and a thumbnail image;
receiving screen control information indicating a display magnification from an information processing device that receives an input of an instruction to change the display magnification of displayed image;
selecting a thumbnail image, from among the plurality of thumbnail images generated at the generating, of an image size matching with the display magnification, contained in the screen control information received at the receiving, and generating display screen information including selected thumbnail image; and
transmitting the display screen information to the image processing device, wherein
the generating includes generating at least a standard thumbnail image of a first standard display size set in advance to be smaller than a size of a display area of the display section.
